(19) United States
(12) Patent Application Publication
(10) Pub. No.: US 2025/0111315 A1
(43) Pub. Date: Apr. 3, 2025

(54) SYSTEMS AND METHODS FOR PROVIDING DYNAMIC INSIGHT REPORTS

(71) Applicant: Wells Fargo Bank, N.A., San Francisco, CA (US)

(72) Inventors: David Szmigielski, New York, NY (US); Kaila Frohna, New York, NY (US)

(21) Appl. No.: 18/478,635

(22) Filed: Sep. 29, 2023

(51) Int. Cl. G06Q 10/0635; G06Q 30/0283

(52) U.S. Cl. CPC G06Q 10/0635; G06Q 30/0283

(57) ABSTRACT

Systems, apparatuses, methods, and computer program products are disclosed for generating an insight report for an entity. An example method includes identifying an entity asset set for the entity, wherein (i) the entity asset set comprises one or more entity assets associated with the entity, (ii) each entity asset is associated with an entity asset type, and (iii) each entity asset is further associated with a geographic area. The example method further includes determining one or more risk scores for each entity asset included in the entity asset set and generating one or more insights for each entity asset included in the entity asset set. The example method further includes generating and providing the insight report for the entity.

### BACKGROUND

An entity, such as a company or other organization, may be associated with various entity assets, such as office buildings, headquarters, satellite offices, or other physical infrastructure. The environment in which the various entity assets are located may affect the performance and/or operations of the entity. Similarly, the operations of each entity asset may affect its surrounding environment.

### BRIEF SUMMARY

As described above, an entity may be associated with various entity assets that occupy a physical space such that these entity assets are associated with a physical footprint. Each entity asset may further consume resources (e.g., water, electricity, gas, timber, etc.) and in some examples, may further output products (e.g., steam, effluent, solid waste, etc.) into the surrounding environment. Thus, each entity asset may have associated risks and dependencies for operating within a particular environment. For example, a risk for an entity asset may be dependent upon a suitability of the environment for productive operation of the entity asset, an overall impact on the environment caused by the operations of the entity asset, and the overall sensitivity of the environment itself. Thus, measuring localized risks and dependencies of each individual entity asset is a complicated process that is highly dependent upon both the environment corresponding to the physical location of the entity asset and the entity asset operations. It is, in turn, even more complicated to assess generalized overall risks to an organization posed by the locations of its entity assets.

Conventionally, such risk may be manually determined by users. However, these manual risk determinations often fail to take into account the localized differences between relevant environments, such that the resulting risk scores are inaccurate. Furthermore, conventional methods fail to address the reasoning for a risk score. This lack of insight makes it difficult for an entity to effectively take actions to mitigate operational risk stemming from the locations of its various entity assets. Furthermore, due to the highly localized nature of entity asset risk, currently entities lack the tools to systematically evaluate and understand what contributing factors may lead to heightened risk exposure.

Example embodiments described herein may be used to generate an insight report, which may be distributed to the entity, to entity advisors, or other external entities (e.g., investors, customers, business partners, etc.). The insight report may provide one or more insights regarding entity assets associated with the entity, such as risk scores for those entity assets, and an explanation of the contributing factors that underpin the various risk scores associated with the entity assets. As such, the end users may review the insight report to gain a better understanding of the risk associated with the entity as a whole as well as the risk associated with each entity asset. The insight report may also include one or more nature risk scores for the entity assets, such as an entity physical or transitional risk score relating to an entity's exposure to areas such as biodiversity, ocean, land, climate freshwater, and communities. Each risk score may be associated with its own set of evaluation criteria that is used to determine the particular risk score for each entity asset. Additionally, one or more global risk scores, such as a global entity physical nature risk score and/or a global entity transitional nature risk score may be determined for the entity. The insight report may include these risk scores as well as the one or more insights, which provide an explanation of an inferred cause for a risk score associated with the entity asset, and/or one or more global insights, which provide an explanation of an inferred cause for a global risk score associated with the entity. Additionally, the insight report may provide an entity risk ranking indicative of a relative ranking of the entity as compared to other comparable entities. Thus, the end users may be made aware of how the entity is performing relative to other, similar entities.

Additionally, embodiments described herein leverage available data sources to automatically determine the one or more entity assets associated with the entity. As such, example embodiments are configured to identify entity assets associated with the entity and confirm information about each entity asset, such as the entity asset type and/or associated geographic region. This confirmation ensures that the risk scores determined for the entity asset are accurate and reflective of the most currently-available information. For example, in an instance in which an entity asset was recently sold, embodiments described herein may remove the entity asset from consideration, thereby saving future computational resources associated with performing additional operations for the entity asset.

Furthermore, in some embodiments, the insight report may additionally provide a recommended policy set for one or more entity assets. The recommended policy set may be indicative of one or more optimal entity management policies that are not currently implemented by the entity asset but that may help mitigate risk associated with the entity. The recommended policy set may be generated for specific entity assets such that the local environments of the entity assets are considered. Thus, the recommended policy set includes optimal entity management policies that are determined based on the particular environment of each specific entity asset. Through generation of the recommended policy set, example embodiments thus provide an additional benefit over manual methods of updating entity management policies (which fail to consider granular environmental factors).

Additionally, the insight report may include one or more implementation service offers. An implementation service offer may offer financial assistance or other resource assistance for the entity to aid the entity with implementing one or more changes, updates, modifications, or other improvements to existing entity management policies. Thus, the implementation service offers included in the implementation service offer may provide the entity with the resources required to implement the one or more optimal entity management policies.

In some embodiments, the insight report may include a future entity asset recommendation and/or a future entity asset request. A future entity asset request may allow users to provide information concerning plans for a new, future entity asset and embodiments described herein may provide a future entity asset recommendation for the future entity asset. The future entity asset recommendation may provide one or more recommended geographic areas to place a future entity asset of a particular entity asset type. The one or more recommended geographic areas may be geographic areas associated with one or more relatively low risk scores for the entity asset as compared to other geographic areas. Thus, the entity may automatically be provided with optimal placement locations for a future entity asset without having to manually search and evaluate these locations, as is conventionally done.

In some embodiments, the insight report may include a scenario response and/or a scenario request. A scenario response may allow users to provide information for a scenario of interest and embodiments described herein may provide a scenario response that includes predicted risk scores and predicted insights determined for various entity assets under the conditions imposed by the scenario. Thus, the scenario response may provide the entity with one or more insights into how various operational changes may affect one or more entity assets of the entity. This may aid the entity with identifying weak points of individual entity assets as well as the entity as a whole and thus allow the entity to begin contingency planning prior to encountering potential adverse impacts caused by such a scenario playing out. This may be particularly beneficial for entities that are particularly sensitive to environmental changes.

Additionally, embodiments described herein may leverage parallel processing to simultaneously process various inputs and generate various outputs. For example, generating a recommended policy set for one or more entity assets, generating implementation service offers for each optimal entity management policy, identifying candidate entity assets, determining geographic areas, etc. may be performed simultaneously through the use of multiple sets of computing infrastructure, which would enable a reduction in the runtime for these various operations, and in some implementations allow the evaluation of multiple scenarios at once, which can enhance overall operational planning processes and ensure that the output information is up-to-date and accurate. The use of enhanced computing infrastructure in this fashion may be of particular importance when performing operations for an entity with a large number of entity assets.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for generating and provides an insight report.

FIG. 2 illustrates a schematic block diagram of example circuitry embodying a system device that may perform various operations in accordance with some example embodiments described herein.

FIG. 3 illustrates an example flowchart for generating and providing an insight report, in accordance with some example embodiments described herein.

FIG. 4 illustrates an example flowchart for identifying an entity asset set, in accordance with some example embodiments described herein.

FIG. 5 illustrates an example flowchart for determining an entity risk ranking, in accordance with some example embodiments described herein.

FIG. 6 illustrates an example flowchart for generating a recommended policy set, in accordance with some example embodiments described herein.

FIG. 7 illustrates an example flowchart for generating and providing an implementation service offer message, in accordance with some example embodiments described herein.

FIG. 8 illustrates an example flowchart for generating and providing a future entity asset recommendation response, in accordance with some example embodiments described herein.

FIG. 9 illustrates an example flowchart for generating and providing a scenario response, in accordance with some example embodiments described herein.

FIG. 10 illustrates an example user interface depicting an example insight report, as used in some example embodiments described herein.

FIG. 11A illustrates an example user interface depicting an entity physical nature risk heat map, as used in some example embodiments described herein.

FIG. 11B illustrates an example user interface depicting an entity transitional nature risk heat map, as used in some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” or “device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

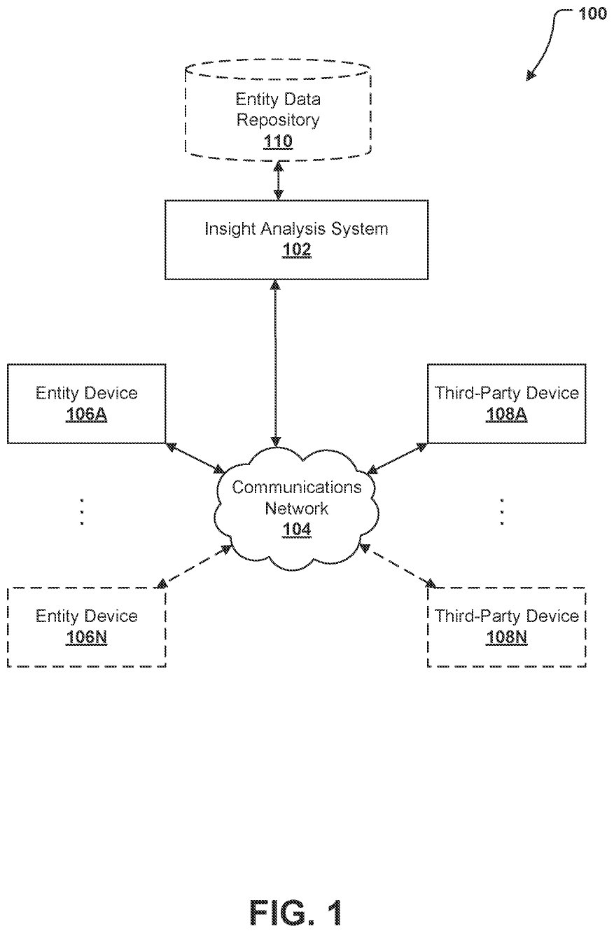

Example embodiments described herein may be implemented using any of a variety of computing devices or servers. To this end, FIG. 1 illustrates an example environment 100 within which various embodiments may operate. As illustrated, the insight analysis system 102 may receive and/or transmit information via communications network 104 (e.g., the Internet) with any number of other devices, such as one or more of entity devices 106A-106N and/or third-party devices 108A-108N.

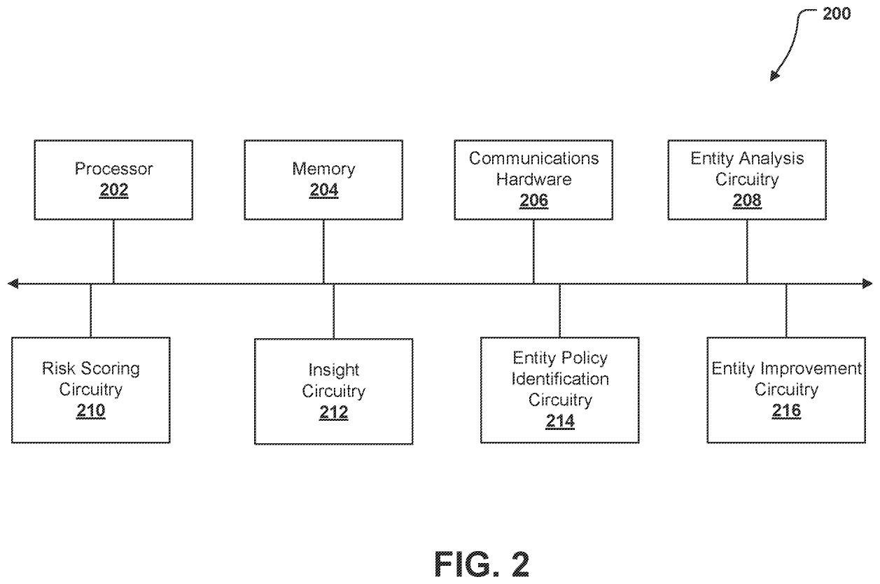

The insight analysis system 102 may be implemented as one or more computing devices or servers, which may be composed of a series of components. Particular components of the insight analysis system 102 are described in greater detail below with reference to apparatus 200 in connection with FIG. 2.

In some embodiments, the insight analysis system 102 further includes an entity data repository 110 that comprises a distinct component from other components of the insight analysis system 102. The entity data repository 110 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). The entity data repository 110 may host the software executed to operate the insight analysis system 102. The entity data repository 110 may store information relied upon during operation of the insight analysis system 102, such as various machine learning models or other models that may be used by the insight analysis system 102, data and documents to be analyzed using the insight analysis system 102, or the like. In addition, entity data repository 110 may store control signals, device characteristics, and access credentials enabling interaction between the insight analysis system 102 and one or more of the entity devices 106A-106N or third-party devices 108A-108N.

The one or more entity devices 106A-106N and the one or more third-party devices 108A-108N may be embodied by any computing devices known in the art. The one or more entity devices 106A-106N and the one or more third-party devices 108A-108N need not themselves be independent devices, but may be peripheral devices communicatively coupled to other computing devices. In some embodiments, the one or more entity devices 106A-106N may be associated with the entity for which the insight report is being generated. The one or more entity devices 106A-106N may each be associated with a particular entity asset (e.g., offices, headquarters, satellite office, etc.). In some embodiments, the one or more entity devices 106A-106N may be configured to provide the insight analysis system 102 with entity data, such as a resource consumption set for the corresponding entity asset or a resource consumption set for a plurality of entity assets. The one or more entity devices 106A-106N may additionally be configured to receive user input from authorized entity users (e.g., employers, administrators, managers, etc.) and in response, provide the insight analysis system 102 with an insight report request, an indication of a future entity asset, a scenario request, and/or the like. In some embodiments, the one or more third-party device 108A-108N may be associated with a particular entity. For example, third-party devices 108A-108C may be associated with a first data vendor and third-party devices 108D-108E may be associate with a second data vendor.

Although FIG. 1 illustrates an environment and implementation in which the insight analysis system 102 interacts indirectly with a user via one or more of entity devices 106A-106N and/or third-party devices 108A-108N, in some embodiments users may directly interact with the insight analysis system 102 (e.g., via communications hardware of the insight analysis system 102), in which case a separate entity devices 106A-106N and/or third-party devices 108A-108N may not be utilized. Whether by way of direct interaction or indirect interaction via another device, a user may communicate with, operate, control, modify, or otherwise interact with the insight analysis system 102 to perform the various functions and achieve the various benefits described herein.

### Example Implementing Apparatuses

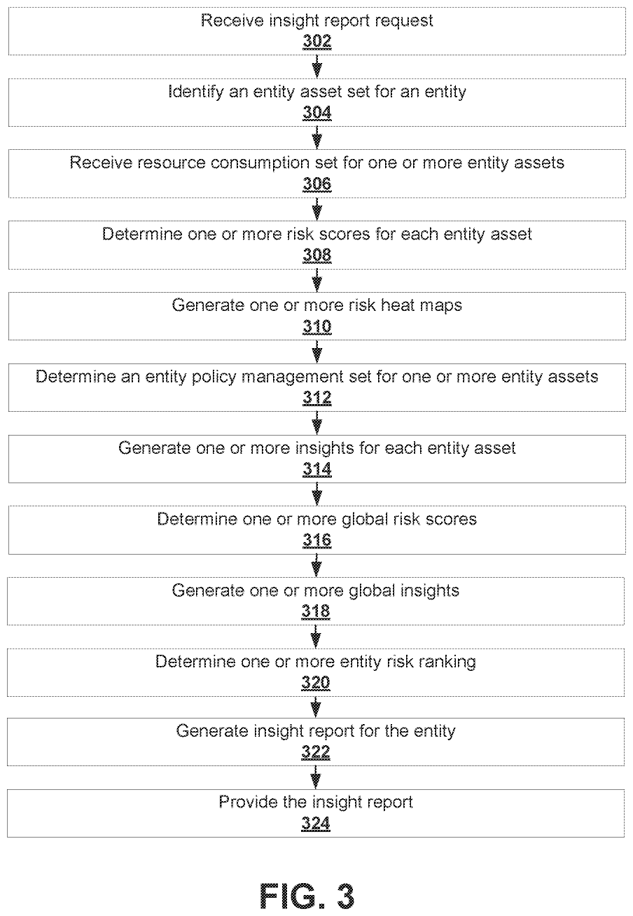

The insight analysis system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-9. As illustrated in FIG. 2, the apparatus 200 may include processor 202, memory 204, communications hardware 206, entity analysis circuitry 208, risk scoring circuitry 210, insight circuitry 212, entity policy identification circuitry 214, and/or entity improvement circuitry 216, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represents a system (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

The apparatus 200 further comprises entity analysis circuitry 208 that may be configured to identify an entity asset set for an entity. In some embodiments, the entity analysis circuitry 208 may further be configured to query one or more data sources for entity asset information, identify one or more candidate entity assets from the query, and/or determine a geographic area associated with each of the one or more candidate entity assets. In some embodiments, the entity analysis circuitry 208 may be further configured to identify one or more comparative entities. The entity analysis circuitry 208 may utilize processor 202, memory 204, or any other hardware component included in the apparatus 200 to perform these operations, as described in connection with FIGS. 3-9 below. The entity analysis circuitry 208 may further utilize communications hardware 206 to gather data from a variety of sources (e.g., entity devices 106A through 106N, third-party devices 108A through 108N, and/or entity data repository 110, as shown in FIG. 1), and/or exchange data with a user, and in some embodiments may utilize processor 202 and/or memory 204.

The apparatus 200 further comprises risk scoring circuitry 210 that may be configured to determining one or more risk scores for each entity asset included in the entity asset set. In some embodiments, the risk scoring circuitry 210 may further be configured to determine one or more candidate geographic areas for a future entity asset, determine one or more risk scores for the one or more candidate geographic areas, and determine one or more recommended geographic areas. In some embodiments, the risk scoring circuitry 210 may further be configured to generate one or more predicted risk scores for each entity asset included in the entity asset set. In some embodiments, the risk scoring circuitry 210 may further be configured to determine one or more global risk scores. The risk scoring circuitry 210 may utilize processor 202, memory 204, or any other hardware component included in the apparatus 200 to perform these operations, as described in connection with FIGS. 3-9 below. The risk scoring circuitry 210 may further utilize communications hardware 206 to gather data from a variety of sources (e.g., entity devices 106A through 106N, third-party devices 108A through 108N, and/or entity data repository 110, as shown in FIG. 1), and/or exchange data with a user, and in some embodiments may utilize processor 202 and/or memory 204.

The apparatus 200 further comprises insight circuitry 212 that may be configured to generate one or more insights for each entity asset included in the entity asset set and/or generate an insight report. In some embodiments, the insight circuitry 212 may further be configured to generate one or more predicted insights for each entity asset included in the entity asset set. In some embodiments, the insight circuitry 212 may further be configured to generate one or more global insights for the entity. In some embodiments, the insight circuitry 212 may further be configured to determine an entity risk ranking. In some embodiments, the insight circuitry 212 may further be configured to generate one or more risk heat maps. The insight circuitry 212 may utilize processor 202, memory 204, or any other hardware component included in the apparatus 200 to perform these operations, as described in connection with FIGS. 3-9 below. The insight circuitry 212 may further utilize communications hardware 206 to gather data from a variety of sources (e.g., entity devices 106A through 106N, third-party devices 108A through 108N, and/or entity data repository 110, as shown in FIG. 1), and/or exchange data with a user, and in some embodiments may utilize processor 202 and/or memory 204.

The apparatus 200 further comprises entity policy identification circuitry 214 that may be configured to, for each entity asset in the entity asset set, determine an entity policy management set, determine an optimal entity policy management set, identify one or more optimal entity management policies that are not included in the entity policy management set, and/or generate a recommended policy management set. The entity policy identification circuitry 214 may utilize processor 202, memory 204, or any other hardware component included in the apparatus 200 to perform these operations, as described in connection with FIGS. 3-9 below. The entity policy identification circuitry 214 may further utilize communications hardware 206 to gather data from a variety of sources (e.g., entity devices 106A through 106N, third-party devices 108A through 108N, and/or entity data repository 110, as shown in FIG. 1), and/or exchange data with a user, and in some embodiments may utilize processor 202 and/or memory 204.

The apparatus 200 further comprises entity improvement circuitry 216 that may be configured to, for each optimal entity management policy included in a recommended policy set, determine an implementation cost estimate and/or generate an implementation service offer. The entity improvement circuitry 216 may utilize processor 202, memory 204, or any other hardware component included in the apparatus 200 to perform these operations, as described in connection with FIGS. 3-9 below. The entity improvement circuitry 216 may further utilize communications hardware 206 to gather data from a variety of sources (e.g., entity devices 106A through 106N, third-party devices 108A through 108N, and/or entity data repository 110, as shown in FIG. 1), and/or exchange data with a user, and in some embodiments may utilize processor 202 and/or memory 204.

Although components 202-216 are described in part using functional language, it will be understood that the particular implementations necessarily include the use of particular hardware. It should also be understood that certain of these components 202-216 may include similar or common hardware. For example, the entity analysis circuitry 208, risk scoring circuitry 210, insight circuitry 212, entity policy identification circuitry 214, and/or entity improvement circuitry 216 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the entity analysis circuitry 208, risk scoring circuitry 210, insight circuitry 212, entity policy identification circuitry 214, and entity improvement circuitry 216 may leverage processor 202, memory 204, or communications hardware 206 as described above, it will be understood that any of entity analysis circuitry 208, risk scoring circuitry 210, insight circuitry 212, entity policy identification circuitry 214, and entity improvement circuitry 216 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that entity analysis circuitry 208, risk scoring circuitry 210, insight circuitry 212, entity policy identification circuitry 214, and entity improvement circuitry 216 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of graphical user interfaces and flowcharts.

### Example Operations

Turning to FIGS. 3-9, example flowcharts are illustrated that contain example operations implemented by example embodiments described herein. The operations illustrated in FIGS. 3-9 may, for example, be performed by system device of the insight analysis system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, entity analysis circuitry 208, risk scoring circuitry 210, insight circuitry 212, entity policy identification circuitry 214, entity improvement circuitry 216 and/or any combination thereof. It will be understood that user interaction with the insight analysis system 102 may occur directly via communications hardware 206, or may instead be facilitated by a separate device, which may have similar or equivalent physical componentry facilitating such user interaction.

### Generating an Insight Report

Turning first to FIG. 3, example operations are shown for generating and providing an insight report. The insight report may provide one or more insights regarding entity assets associated with the entity, such as an explanation of the contributing factors that were determined for various risk scores associated with the various entity assets. The insight report may provide one or more insights regarding entity assets associated with the entity, such as an explanation of the contributing factors that were determined for various risk scores associated with the various entity assets. As such, the end users may review the insight report to gain a better understanding of the risk associated with the entity as a whole as well as the risk associated with each entity asset. Additional information may be provided in the insight report. The content included in the insight report may be based on an initially received insight report request, which may include an indication of the content requested to be included the insight report.

As shown by operation 302, the apparatus 200 includes means, such as processor 202, memory 204, communications hardware 206, entity analysis circuitry 208 and/or the like, for receiving an insight report request. In some embodiments, communications hardware 206 may receive an insight report request from an entity device, such as any one of entity devices 106A-106N. Alternatively, the communications hardware 206 may receive an insight report request from a third-party device, such as any one of third-party devices 108A-108N. Receipt of the insight report request may trigger apparatus 200 to perform one or more subsequent operations (e.g., operations 304-324) to generate and provide an insight report to the requesting device (e.g., entity device 106A-106N and/or client device 108A-108N).

The insight report request may be indicative of a request for an insight report to be generated for a particular entity and/or a requesting entity. The insight report request may include an indication of the entity requesting the insight report. For example, the insight report request may include an indication of an entity, such as an entity name (e.g., “Company [XXX]”), entity domain indicator (e.g., email domain, html domain, entity website, etc.), entity device indicator (e.g., media access control (MAC) address, phone number, serial number, international mobile equipment identity (IMEI) number, etc.), an entity identifier, and/or the like.

In some embodiments, apparatus 200 may use an entity look-up table to identify a requesting entity and/or entity to which the insight report pertains to. The entity look-up table may be stored in an associated memory, such as memory 204, entity data repository 110, or another storage location. The entity analysis circuitry 208 may be configured to use the entity indication provided in the insight report request to query the entity look-up table for the corresponding entity. The entity look-up table may include one or more entity identifiers, which each uniquely each entity. Each entity identifier may further be associated with one or more entity indicators such that the entity analysis circuitry 208 may use provided identity indicators to identify the entity identifier for the entity. Each entity identifier may further be associated with entity data, such as an entity asset set, historical insight reports, current and/or historical resource consumption sets for associated entity assets, current and/or historical entity policy management sets for associated entity assets, current and/or historical risk scores for associated entity assets, current and/or historical risk heat maps, current and/or historical insights for associated entity assets, current and/or historical global risk scores, current and/or historical global insights, historical recommended policy sets, historical implementation service offers, current and/or historical entity risk rankings, historical received requests and/or responses (e.g., future entity asset indications, future entity asset recommendation response, scenario request, scenario response, etc.). The entity data associated with the entity identifier stored in the entity look-up table may be updated and/or managed by the entity analysis circuitry 208 such that the entity data reflects up-to-date and accurate information for the corresponding entity.

The entity identifier may further be associated with one or more authorized communication channels, entities, users, parties, and/or devices, which may provide apparatus 200 with instructions for providing a response to a received request. For example, the entity identifier may be associated with entity devices 106A-106N and third-party devices 108A-108C. Entity devices 106A-106N and third-party devices 108A-108C may be associated with permissions for receiving an insight report but only entity devices 106A-106N may be associated with permission for receiving additional responses (e.g., a future entity asset recommendation response, a scenario response, etc.). As another example, the entity identifier may be associated with certain user credentials such that these user credentials must be provided in the insight report request prior to apparatus 200 generating a response. In an instance in which an entity, user, party, device, etc. provides a request for a response that it does not have permissions for, entity analysis circuitry 208 may use communications hardware 206 to provide an unauthorized access message to the requesting entity, user, party, device, etc. indicative that this information is not accessible.

In some embodiments, the query of the entity look-up table using the entity indicators provided in the insight report request may be return empty query results. This may be due to the entity not currently having an entry and entity identifier in the entity look-up table. In some embodiments, receipt of empty query results may cause the entity analysis circuitry 208 to generate a new entity identifier for the entity described by the insight report request and associated with the provided entity indicators with the entity identifier. In some embodiments, the entity analysis circuitry 208 may request an authorized user (e.g., a user associated with the insight analysis system 102) to manually review the new entity identifier and provide an indication of authorized communication channels, entities, users, parties, and/or devices and permissions prior to proceeding. Alternatively, the entity analysis circuitry 208 may proceed with subsequent operations and take additional action prior to providing responses to a requesting entity or device. For example, the entity analysis circuitry 208 may provide the generated insight report to a user or device associated with the insight analysis system 102 prior to providing the insight report to other devices (e.g., entity devices 106A-106N and/or third-party devices 108A-108N).

As shown by operation 304, the apparatus 200 includes means, such as processor 202, memory 204, communications hardware 206, entity analysis circuitry 208, and/or the like, for identifying an entity asset set for an entity. Once the entity analysis circuitry 208 has determined that the insight report request is valid (e.g., has verified the requesting entity or device is associated with appropriate permissions), the entity analysis circuitry 208 may identify the entity asset set for the entity. In some embodiments, the entity asset set is stored in the entity look-up table and is associated with the entity identifier. As such, the entity analysis circuitry 208 may identify the entity asset set for the entity using the entity identifier and the entity look-up table, which may be stored and/or maintained in memory 204 or entity data repository 110.

The entity asset set may include one or more entity assets that are determined to be associated with the entity. Each entity asset may be associated with an entity asset type that describes the particular type or category to which the entity asset belongs. For example, an entity asset type may include an office, headquarters, satellite office, program, development area, major pipeline, minor pipeline, worksite, warehouse, drilling site, mining site, water treatment facility, and/or the like. In some embodiments, each entity asset type may be associated with an entity asset type requirement set which includes one or more entity asset type requirements. An entity asset type requirement describes a particular requirement needed to ensure the entity asset is fully operational. The one or more entity asset type requirements for a given entity asset type may be common or shared amongst each entity asset corresponding to the entity asset type. For example, an office entity asset type may be associated with entity asset type requirements of access to water utilities, access to electricity, and access to sewage utilities. Additionally, in some embodiments, the entity asset type requirement set may further include one or more entity asset outputs produced by entity assets of a given entity asset type. For example, the entity asset type requirement set may indicate that certain entities types typically produce entity asset outputs, such as steam, effluent, solid waste, etc. The entity asset type requirement set may be common amongst each entity asset corresponding to the entity asset type. However, it will be appreciated that the volume or amount of requirements and/or outputs may vary between individual entity assets of a given entity asset type. In some embodiments, the entity asset type requirement set may further include estimated ranges that provide estimates of required amounts or volumes of certain resources and/or produced entity asset outputs, which may be based on collected and analyzed historical data.

Additionally, each entity asset may be associated with a geographic area that corresponds to the physical location of the entity asset. The geographic area may define a bounded geographic region which the entity asset occupies or is associated with. For example, a bounded geographic region may define a plot of land on which an entity asset (e.g., an office) is physically located as well as the surrounding area associated with the plot of land. In some example, the geographic area associated with the entity asset may additionally be associated with certain rights or permissions for geographic features. For example, the geographic area may include a body of water and the entity asset may have riparian rights, littoral rights, etc. to said body of water. In some embodiments, the geographic area may correspond to a particular address, which may be associated with a property lines.

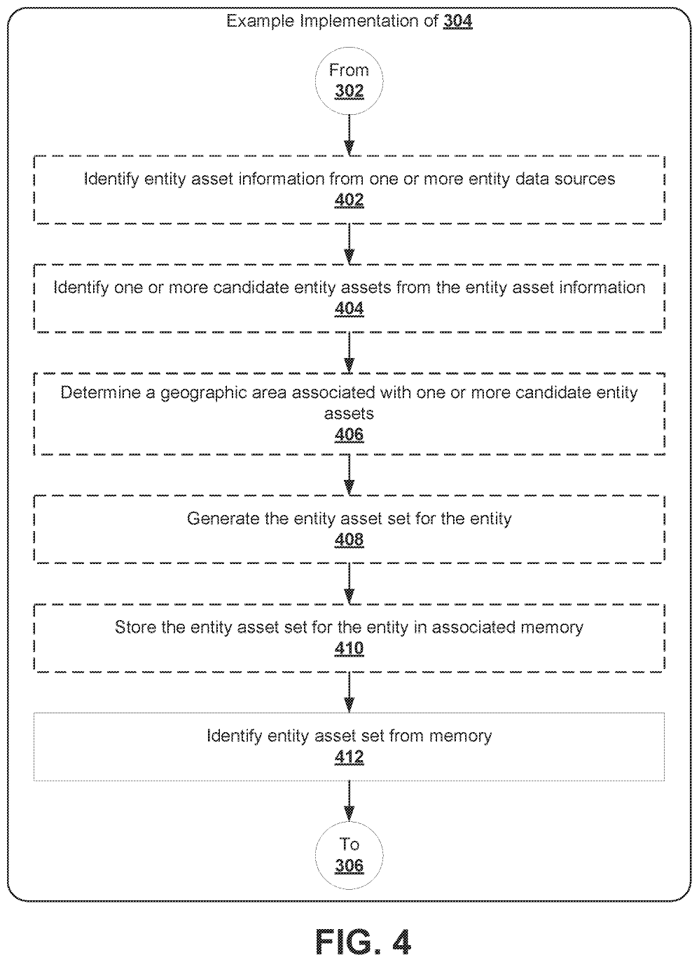

In some embodiments, operation 304 may be performed in accordance with the operations described by FIG. 4. Turning now to FIG. 4, example operations are shown for identifying an entity asset set for the entity. In some embodiments, operations 402-410 may performed to yield an entity asset set that may be stored in an associated memory (e.g., memory 204, entity data repository 110, or a different associated memory). As such, it will be appreciated that operations 402-410 may be optional processes that need not be performed in each instance to identify an entity asset set. In some embodiments, operations 402-410 may be performed periodically or semi-periodically to ensure the entity asset set is up-to-date and accurate.

As shown by operation 402, the apparatus 200 includes means, such as processor 202, memory 204, communications hardware 206, entity analysis circuitry 208, and/or the like, for identifying entity asset information from one or more entity data sources. In some embodiments, the entity analysis circuitry 208 may determine to search one or more entity data sources for entity asset information, such as in response to determining a current entity identifier does not exist for the entity in the entity look-up table, determining the most current update to the entity asset set was performed over a threshold time period ago, receiving an indication of a new entity asset for the entity, etc. The one or more entity data sources used by the entity analysis circuitry 208 may correspond to verified or trusted online sources. For example, entity data sources may include the official website of the entity, publically available reports from the entity, reports pertaining to the entity published by a verified source, mapping software, or other data sources that provide an indication of entity assets. Once the entity analysis circuitry 208 has searched the one or more entity data sources, the entity analysis circuitry 208 may identify the entity asset information from the entity data sources.

The entity analysis circuitry 208 may search the one or more data sources for entity asset information. Entity asset information may pertain to any information related to a particular entity. In some embodiments, the entity analysis circuitry 208 may be configured to use a web crawler and/or one or more identification models to identify entity asset information. The one or more identification models may use various image-processing tools, such as optical character recognition (OCR) and/or language processing techniques to identify and extract entity asset information from the one or more entity data sources.

In some embodiments, the entity may grant or provide apparatus 200 with limited permissions that allow apparatus 200 to access certain entity asset information from a private network or database associated with the entity. Thus, the entity analysis circuitry 208 may use the communications hardware 206 to access and query the private network or database for entity asset information.

Entity asset information may include text and/or images pulled from the various entity data sources. For example, entity asset information may include a snapshot of the “locations” page from the official entity website, journal articles with references to the entity, listing or records of real estate purchased or owned by the entity, social media data from or referencing the official social media handle of the entity, and/or the like.

As shown by operation 404, the apparatus 200 includes means, such as processor 202, memory 204, communications hardware 206, entity analysis circuitry 208, and/or the like, for identifying one or more candidate entity assets from the entity asset information. In some embodiments, the entity analysis circuitry 208 may use one or more information processing models to process the entity asset information and identify and output the one or more candidate entity assets. The one or more information processing models may be stored in an associated memory, such as memory 204 or entity data repository 110, such that the entity analysis circuitry 208 may access the one or more information processing models from the associated memory.

An information processing model may be a machine learning model or rules-based model that is configured to process text, images, metadata, or other content associated with the entity asset information. In some embodiments, the information processing model may be a language model, such as an n-gram language model, a maximum entropy language model, a neural network, or a large language model (LLM). The information processing model may additionally or alternatively use natural language processing (NLP) techniques to process the entity asset information and output the one or more candidate entity assets. In some embodiments, an information processing model may additionally or alternatively be configured to process entity asset information formatted as images to identify one or more candidate entity assets. The information processing model may be a neural network, such as a convolutional neural network (CNN) or deep neural network (DNN) that may be configured to process images to identify candidate entity assets. The one or more information processing models may further identify an entity asset type for each entity asset based on the inferred context from the entity asset information.

The one or more information processing models may be trained to identify key terms, key phrases, patterns, and/or the like within the entity asset information to identify the candidate entity assets. For example, the information processing models may be configured to monitor for terminology that corresponds to set entity asset types (e.g., “office”, “headquarters”, etc.). By way of particular example, an information processing model may be configured to process the text “Company [XXX]'s headquarters, set in the city ABC . . . ” and identify a candidate entity asset corresponding to a headquarters entity asset type.

As shown by operation 406, the apparatus 200 includes means, such as processor 202, memory 204, communications hardware 206, entity analysis circuitry 208, and/or the like, for determining a geographic area associated with one or more candidate entity assets. Once the entity analysis circuitry 208 has identified one or more candidate entity assets from the entity asset information, the entity analysis circuitry 208 may determine a geographic area for candidate entity assets. In some embodiments, the geographic area for the candidate entity asset may be determined simultaneously with identification of the candidate entity asset or the determination of a corresponding entity asset type. In some embodiments, the geographic area may correspond to a particular address, which may be associated with a property lines.

The entity analysis circuitry 208 may use one or more information processing models to determine the geographic area associated with the one or more candidate entity assets, similar to operation 404. The one or more information processing models used to determine the geographic area associated with the one or more candidate entity assets may be the same information processing models configured to identify the one or more candidate entity assets and further, these information processing models may simultaneously determine the geographic area associated with a candidate entity asset when identifying the candidate entity asset. The one or more information processing models may be configured to determine an associated geographic area for a candidate entity asset based on the inferred context from the entity asset information. For example, an information processing model may be configured to determine a geographic area of “123 main street, ABC, North Carolina 12345” from the text “[v]isit our office at ABC office located at 123 main street, ABC, North Carolina 12345”.

In some embodiments, the entity analysis circuitry 208 may be configured to confirm a geographic area output by the one or more information processing models prior to determining the output geographic area is associated with a candidate entity asset. To do so, the entity analysis circuitry 208 may input the geographic area into a mapping software or other real estate software that may be configured to confirm the existence or future plans for the candidate entity asset at the geographic area. For example, the entity analysis circuitry 208 may provide an address as output by the one or more information processing models, into a mapping software, which may return results that confirm the existence of the entity asset at the particular address and in some embodiments, a plot size and/or property lines. In some embodiments, the results may further include supplemental information regarding the candidate entity asset, such as operational status (e.g., open, closed, permanently closed, etc.), operating hours, ratings, phone numbers, images, etc. This supplemental information may optionally be associated with the candidate entity asset.

As shown by operation 408, the apparatus 200 includes means, such as processor 202, memory 204, communications hardware 206, entity analysis circuitry 208, and/or the like, for generating the entity asset set for the entity. In some embodiments, the entity analysis circuitry 208 may generate the entity asset set to include only candidate entity assets for which a geographic area was determined and/or confirmed. In an instance in which a geographic area could not be determined, confirmed, and/or verified for a given candidate entity asset, the entity analysis circuitry 208 may determine to not include the candidate entity asset as an entity asset in the entity asset set.

In some embodiments, the entity analysis circuitry 208 may provide an indication of the determined entity assets included in the entity asset set and/or candidate entity assets that were not included in the entity asset set to one or more users for manual review prior to generating the entity asset set. One or more users, such as authorized users associated with the insight analysis system 102 and/or one or more client devices 106A-106N, may review the candidate entity assets and modify (e.g., add the entity asset to the entity asset set, remove the entity asset from the entity asset set, change entity asset type, change associated geographic area, etc.) the candidate entity asset with respect to the entity asset set. As such, the entity analysis circuitry 208 may remove the burden of manually identifying entity assets but still allows for authorized users to provide feedback to ensure the entity asset set is accurate.

As shown by operation 410, the apparatus 200 includes means, such as processor 202, memory 204, communications hardware 206, entity analysis circuitry 208, and/or the like, for storing the entity asset set for the entity in an associated memory. Once the entity analysis circuitry 208 has generated the entity asset set for the entity, the entity analysis circuitry 208 may store the entity asset set in an associated memory, such as memory 204 and/or entity data repository 110. In some embodiments, the entity analysis circuitry 208 may store the entity asset set as associated with an entity identifier corresponding to the entity within the entity look-up table. As such, the entity asset set for the entity may be identified by querying the entity look-up table for the entity identifier and using the associated, stored entity asset set.

As shown by operation 412, the apparatus 200 includes means, such as processor 202, memory 204, communications hardware 206, entity analysis circuitry 208, and/or the like, for identifying the entity asset set from an associated memory. As described above, once the entity analysis circuitry 208 has generated and stored the entity asset set for the entity, the entity analysis circuitry 208 may identify the entity asset set by querying the associated memory (e.g., memory 204 and/or entity data repository 110) for the entity identifier corresponding to the entity and identifying the entity asset set associated with the entity identifier. In particular, the entity analysis circuitry 208 may query an entity look-up table for the entity identifier to identify the associated entity asset set.

Returning now to FIG. 3, optionally, as shown by operation 306, the apparatus 200 includes means, such as processor 202, memory 204, communications hardware 206, and/or the like, for receiving a resource consumption set for one or more entity assets included in the entity asset set. In some embodiments, the entity may enroll or participate in a program in which one or more devices associated with the entity, such as any one of the one or more entity devices 106A-106N, provide communications hardware 206 with a resource consumption set that corresponds to one or more entity assets. In particular, a resource consumption set may include one or more resource consumption metrics that are collected over a time frame for the entity asset. The one or more resource consumption metrics may be indicative of a type of resource consumed by the entity and a volume or amount of the resource consumed. For example, the one or more resource metrics may be indicative of the amounts of water, electricity, gas, timber, etc. consumed by the entity asset over the time frame (e.g., one day, one week, one month, etc.). In some embodiments, the one or more resource consumption metrics may further be indicative of a type of consumed resource output by the entity and a volume or amount of the resource output. For example, the one or more resource metrics may be indicative of the amounts of steam, effluent, solid waste, etc. output by the entity asset over the time frame (e.g., one day, one week, one month, etc.).

In some embodiments, the resource consumption metrics may further be indicative of the rate at which resources were consumed and/or consumed resource output, such as by including sub-time interval measurements. For example, resource consumption metrics may indicate the entity asset used 6000 kilowatt-hours (kWh) of electricity over the course of a month and may further provide a sub-interval measurements of kilowatt-hours consumed per day within the month. As such, resource consumption trends may be established for the entity asset.

As shown by operation 308, the apparatus 200 includes means, such as processor 202, memory 204, communications hardware 206, risk scoring circuitry 210, and/or the like, for determining one or more risk scores for each entity asset included in the entity asset set. The risk scoring circuitry 210 may determine one or more risk scores for each entity asset based on the corresponding entity asset type as well as the corresponding geographic area associated with the entity asset. In some embodiments, the risk scoring circuitry 210 may additionally define a surrounding environmental area for the entity asset. The surrounding environmental may be a bounded geographic region that includes geographic areas which the entity asset may effect. For example, a geographic area associated with the entity asset may be an address that includes the physical location of the entity asset as well as any owned or licensed physical land or water sources whereas a surrounding environment may include the entirety of a city, county, park, or other defined boundary in which the entity asset resides. In some embodiments, the risk scoring circuitry 210 determines the surrounding environment for a given entity asset by determining a geographic area that falls within a perimeter defined by a predefined radius extending from the physical location of the entity asset. For example, a surrounding environment for an entity asset may include the geographic area that is 20 miles or less from the address of the entity asset.

In some embodiments, the risk scoring circuitry 210 may determine the one or more risk scores for an entity asset by using one or more risk scoring models. A risk scoring model may be a machine learning model or a rules-based model configured to process the entity asset set and in some embodiments, the resource consumption sets for one or more entity assets, to determine the one or more risk scores for the entity asset. In some embodiments, the risk scoring model may be a neural network or a DNN that is configured to infer a risk score for the entity based on individualized scoring criteria particular to a type of risk score, as discussed in further detail below. The one or more risk scoring models may output the one or more risk scores as output. In some embodiments, each risk scoring model is trained to determine a risk score for the entity asset according to risk score type specific criteria such that each risk scoring model is associated with a particular risk score type. In some embodiments, the one or more risk scores may include an entity physical nature risk score and/or an entity transitional nature risk score. In some embodiments, the one or more determined risk scores may be numerical and exist within a particular numerical range. For example, the one or more risk scores may correspond to a value between 0 and 1 or 0 to 100 where a value of 0 is indicative of a minimum amount of risk (e.g., no risk) and a value of 1 or 100 is of a maximum risk. Alternatively, the one or more determined risk scores may be categorical. For example, the one or more risk scores may correspond to a category between 1 and 5, where a category of 1 is indicative of no risk, a category of 2 is indicative of low risk, a category of 3 is indicative of medium risk, a category of 4 is indicative of high risk, and a category of 5 is indicative of very high risk.

An entity physical nature risk score may be indicative of an inferred risk an entity asset faces related to: (i) its dependence on the state of the biodiversity in the geographic area and/or surrounding environment, (ii) its inferred impact on biodiversity for the surrounding environment, and (iii) the overall sensitivity of the geographic area and/or surrounding environment. In particular, a risk scoring model may determine an entity physical nature risk score for an entity asset based on an availability of resources within the surrounding environment required to operate the entity asset. As described above, different entity asset types may be associated with an entity asset type requirement set which includes one or more entity asset type requirements. Each entity asset type requirement describes a particular requirement needed to ensure the entity asset is fully operational. The risk scoring model may evaluate the geographic area associated with the entity asset for an availability or ease of availability of these resources that satisfy these requirements. For example, a risk scoring model may evaluate a proximity of the entity asset to electricity utilities (e.g., number of electricity producers that service the geographic area, overall grid coverage, etc.) as well as an accessibility to electricity utilities (e.g., whether current infrastructure exists, the age of power lines or grid system, historical outages, etc.) when determining an entity physical nature risk score for an office entity asset type. In an instance in which an entity asset is associated with a given resource consumption set, the risk scoring model may process the resource consumption set to further refine and determine a more accurate the entity physical nature risk score for the entity asset that considers actual resources consumed by the entity asset.

Additionally, the risk scoring model may determine the entity physical nature risk score for the entity asset based on the inferred impact of the entity asset of the geographic area and/or surrounding environment. In an instance in which the entity asset type requirement set associated with the entity asset type includes one or more entity asset outputs, the risk scoring model may determine an inferred impact on the surrounding environment caused directly or indirectly by the one or more entity asset outputs. In an instance in which an entity asset is associated with a given resource consumption set, the risk scoring model may process the resource consumption set to further refine and determine a more accurate the entity physical nature risk score for the entity asset that considers actual consumed resource output produced by the entity asset.

Furthermore, the risk scoring model may determine an entity physical nature risk score for the entity asset based on a sensitivity of the surrounding environment and/or geographic area to weather events. For example, the risk scoring model may determine how susceptible the geographic area associated with the entity asset or the surrounding environment is to weather events (e.g., tornados, hurricanes, blizzards, droughts, heat waves, flooding, landslides, high winds, hail, thunderstorms, etc.) or other environmental events (e.g., earthquakes, wildfires, etc.).

An entity transitional nature risk score may be indicative of an inferred risk an entity asset faces related to regulatory standards, reputational considerations, consumer preferences, and the emergence of new technologies. That is, the entity transitional nature risk score may be indicative of a risk associated with the entities practices and/or operations in view of particular regulatory policies, consumer preferences, technology standards or advancements, and/or the like. In particular, a risk scoring model may determine an entity transitional nature risk score for an entity asset based on whether the geographic area and/or surrounding area is associated with one or more environmentally sensitive topics. For example, the risk scoring model may determine whether the geographic area and/or surrounding environment is associated with land deemed to be a key biodiversity area or other protected area (e.g., protected lands, national parks, wilderness study areas, conservation lands, nature reserves, habitat for endangered animal species, etc.). Additionally, the risk scoring model may determine a human rights state associated with the geographic area and/or surrounding environment when determining the entity transitional nature risk score. For example, the risk scoring model may determine whether labor protections exist within the environment and to the extent these protections are enforced and/or followed, the existence of human rights violations, and/or the like. Furthermore, the risk scoring model may determine the existence of culturally sensitive populations within the geographic area and/or surrounding area, such as indigenous people, when determining the entity transitional nature risk score.

Additionally, the risk scoring model may determine the entity transitional nature risk score for the entity asset based on an inferred perceived impact of the entity asset on the geographic area and/or surrounding environment. In an instance in which the entity asset type requirement set associated with the entity asset type includes one or more entity asset outputs, the risk scoring model may determine an inferred impact on the surrounding environment caused directly or indirectly by the one or more entity asset outputs and further, predict a perceived public response to the entity asset outputs and/or lack of entity asset outputs. The risk scoring model may be trained to infer perceived impact based on an analysis of historical media coverage and/or public response to other outputs or events caused directly or indirectly by other entity assets. In an instance in which an entity asset is associated with a given resource consumption set, the risk scoring model may process the resource consumption set to further refine and determine a more accurate the entity transitional nature risk score for the entity asset that considers actual consumed resource output produced by the entity asset.

Optionally, as shown by operation 310, the apparatus 200 includes means, such as processor 202, memory 204, communications hardware 206, risk scoring circuitry 210, and/or the like, for generating one or more risk heat maps. Once the risk scoring circuitry 210 has generated the one or more risk scores for each entity asset, the risk scoring circuitry 210 may generate one or more risk heat maps based on the associated risk scores determined for each entity asset. Each risk heat map may be associated with a risk score type such that the risk heat map is generated based on the determined risk scores that correspond to the given risk score type. By way of particular example, an entity physical nature risk heat map may be representative of the entity physical nature risk scores determined for each entity asset and an entity transitional nature risk heat map may be representative of the entity transitional nature risk scores determined for each entity asset.

A risk heat map may be a graphical representation that uses a color coding scheme to represent different risk score values determined for the entity assets. In some embodiments, a risk heat map may include a map of a broad geographic area and further depicts the location of each entity asset included in the entity asset set using certain markers. The markers style used for the entity asset may be dependent on the given entity asset type. For example, a headquarters entity asset type may be represented on the heat map using a star marker style while an office entity asset type may be represented on the heat map using a circle marker style. The location of the entity asset may also correspond to the associated geographic area. Each marker may additionally be colored or shaded using the heat map color scale such that the color of the marker of a given entity asset is representative of an associated risk score determined for the particular entity asset. In some embodiments, the surrounding environment determined for the entity asset may also be colored or shaded using the heat map color scale.

Optionally, as shown by operation 312, the apparatus 200 includes means, such as processor 202, memory 204, communications hardware 206, entity policy identification circuitry 214, and/or the like, for determining an entity policy management set for one or more entity assets included in the entity asset set. An entity policy management set may include one or more entity management policies that are each indicative of one or more operating rules that the entity asset follows. For example, an entity management policy may include an indication of whether the entity asset recycles, has participated in conservation efforts, has resource conservation policies in place, has restricted expansion or construction plans, uses alternate or non-competing water sources, has safety guidelines in place to mitigate wildfire risk, has policies for invasive species prevention or control, has spill remediation policies, has produced public disclosures regarding entity asset practices as well as the coverage of material within these public disclosures, and/or the like.

In some embodiments, entity management policy sets may be stored and/or maintained in an associated memory, such as memory 204 and/or entity data repository 110. In particular, entity management policy sets associated with a particular entity asset that corresponds to a given entity may be stored in entity look-up table and associated with the entity identifier corresponding to the given entity. As such, the entity policy identification circuitry 214 may determine entity policy management sets for particular entity assets by accessing the associated memory and/or entity look-up table to retrieve the one or more entity policy management sets.

In some the entity policy identification circuitry 214 may determine an entity policy management set for a given entity asset. In particular, similar to operation 402 of FIG. 4, the entity policy identification circuitry 214 may determine to query or search one or more entity data sources for entity asset policy information, such as in response to determining an entity policy management set does not exist for an entity asset, determining the most current update to the entity policy management set was performed over a threshold time period ago, receiving an indication of a new entity management policy for the entity asset, etc. The one or more entity data sources used by the entity policy identification circuitry 214 may correspond to verified or trusted online sources. For example, entity data sources may include the official website of the entity, publically available reports from the entity, reports pertaining to the entity published by a verified source, mapping software, or other data sources that provide an indication of entity assets. Once the entity policy identification circuitry 214 has queried the one or more entity sources, the entity policy identification circuitry 214 may receive the results of the query or search, which may include the entity asset policy information. In some embodiments, in an instance in which operation 402 was already performed by the entity analysis circuitry 208, the entity policy identification circuitry 214 may use the entity asset information obtained by the entity analysis circuitry 208 as the entity asset policy information.

In some embodiments, the entity may grant or provide apparatus 200 with limited permissions that allow apparatus 200 to access certain entity asset policy information from a private network or database associated with the entity. Thus, the entity policy identification circuitry 214 may use the communications hardware 206 to access and query or search the private network or database for entity asset policy information. Entity asset policy information returned from the query or search may include text and/or images pulled from the various entity data sources. For example, entity asset policy information may include articles reporting on policies of a particular entity asset, a curated list of entity asset policies, an employee handbook or guidelines distributed for the entity asset, and/or the like.

In some embodiments, the entity policy identification circuitry 214 may use one or more policy identification models to process the entity asset policy information and identify and output entity management policies that are used to generate the entity policy management set. The one or more policy identification models may be stored in an associated memory, such as memory 204 or entity data repository 110, such that the entity policy identification circuitry 214 may access the one or more policy identification models from the associated memory.

A policy identification model may be a machine learning model or rules-based model that is configured to process text, images, metadata, or other content associated with the entity asset policy information in order to determine one or more entity management policies for a given entity asset. In some embodiments, the policy identification model may be a language model, such as an n-gram language model, a maximum entropy language model, a neural network, or a LLM. The policy identification model may additionally or alternatively use NLP techniques to process the entity asset policy information and output the entity management policies for a given entity asset. In some embodiments, a policy identification model may additionally or alternatively be configured to process entity asset policy information formatted as images to identify one or more entity management policies. The policy identification model may be a neural network, such as a CNN or DNN that may be configured to process images to determine entity management policies from images. The one or more policy identification models may further identify a corresponding entity asset to which the entity management policy pertains to. The one or more policy identification models may be trained to identify key terms, key phrases, patterns, and/or the like within the entity asset policy information to determine the entity management policies and corresponding entity asset to which each entity management policy pertains.

The entity policy identification circuitry 214 may then generate an entity policy management set for a given entity asset based on the one or more entity management policies output by the one or more policy identification models for the entity asset. Once the entity policy identification circuitry 214 has generated the entity policy management set for the entity asset, the entity policy identification circuitry 214 may store the entity policy management set in an associated memory, such as memory 204 and/or entity data repository 110. In some embodiments, the entity policy identification circuitry 214 may store the entity policy management set as associated with an entity identifier corresponding to the entity associated with the entity asset within the entity look-up table. As such, the entity policy management set for the entity asset may be determined by querying the entity look-up table for the entity identifier and using the associated, stored entity policy management set for the given entity asset.

In some embodiments, the entity policy identification circuitry 214 may provide an indication of the determined entity management policies included in a given entity policy management set prior to generating and/or storing the entity policy management set. One or more users, such as authorized users associated with the insight analysis system 102 and/or one or more client devices 106A-106N, may review the entity management policies for a given entity asset and modify (e.g., add an entity management policy, remove an entity management policy, etc.) entity management policies. As such, the entity policy identification circuitry 214 may remove the burden of manually determining entity management policies for each entity asset but still allow authorized users to provide feedback to ensure the entity policy management set is accurate.

As shown by operation 314, the apparatus 200 includes means, such as processor 202, memory 204, communications hardware 206, insight circuitry 212, and/or the like, for generating one or more insights for each entity asset. An insight may be indicative of an inferred cause or reasoning for a particular risk score associated with the entity asset. In some embodiments, the insight circuitry 212 may determine the one or more insights for each entity asset based on the one or more risk scores associated with the entity asset. Additionally, the insight circuitry 212 may determine the one or more insights based on the entity policy management set determined for the entity asset and/or the geographic area with the entity asset.

In some embodiments, the insight circuitry 212 may use one or more insight inference framework to generate the one or more insights. The insight inference framework may include one or more inference models and one or more insight generation models. The one or more inference models may be machine learning models or rules-based models configured to process the one or more risk scores associated with the entity asset and optionally, the entity policy management set and/or geographic area associated with the entity asset and output one or more contributing factors determined to have had a significant impact on the determination of a given risk score for the entity asset. In some embodiments, an inference model may be a neural network, DNN, LLM, regression model, or decision tree. As such, the one or more inference models may provide risk scoring interpretability. In some embodiments, the one or more inference models may be configured to provide the one or more contributing factors to one or more insight generation models.

In some embodiments, each inference model may be trained using historical risk score data of a particular risk score type such that each inference model may be associated with a particular risk score type. In some embodiments, the historical risk score data may be labelled or annotated with known contributing factors such that the inference model may be trained to detect and determine patterns and/or connections between known contributing factors and a given risk score.

The one or more insight generation models may be machine learning models or rules-based models configured to receive the one or more contributing factors determined by the one or more inference models for a given entity asset and generate the one or more insights for the entity asset. In some embodiments, an insight generation model may be a LLM or other language model that is configured to generate text that provides an indication of the contributing factors that influenced a risk score for an entity asset. In some embodiments, each insight generation model may be associated with a particular risk score type. As such, the insight generation model may be configured to process contributing factors output from an inference model that is associated with a risk score type corresponding to its associated risk score type.

Optionally, as shown by operation 316, the apparatus 200 includes means, such as processor 202, memory 204, communications hardware 206, risk scoring circuitry 210, and/or the like, for determining one or more global risk scores. In some embodiments, the risk scoring circuitry 210 may further determine one or more global risk scores for the entity. The one or more global risk scores may be indicative of an overall stability of the entity that is determined in view of a stability of its individual entity assets.

In some embodiments, the risks scoring circuitry 210 may use one or more global risk scoring models to determine the one or more global risk scores. A global risk scoring model may be a machine learning model or a rules-based model configured to process the one or more risk scores determined for each entity asset as well as the geographic area and/or surrounding environment for each entity asset, to determine the one or more global risk scores for the entity. In some embodiments, the global risk scoring model may be a neural network or a DNN that is configured to infer a global risk score for the entity based on individualized scoring criteria particular to a type of risk score, as discussed above. The one or more global risk scoring models may output the one or more global risk scores as output. In some embodiments, each global risk scoring model is trained to determine a global risk score for the entity according to risk score type specific criteria such that each global risk scoring model is associated with a particular global risk score type. In some embodiments, the one or more global risk scores may include a global entity physical nature risk score and/or a global entity transitional nature risk score. In some embodiments, the one or more determined global risk scores may be numerical and exist within a particular numerical range or may be categorical.

Each global risk scoring model may be configured to generate a global risk score for the entity based on the risk scores of a particular risk score type determined for each entity asset. The global risk score for a particular risk score type may thus be a weighted score determined based on these individual risk scores. In some embodiments, the global risk scoring model may further generate a global risk score for the entity based on a variance in the one or more risk scores for the entity assets, a risk score mean determined based on the one or more risk scores for the entity assets, a risk score mode determined based on the one or more risk scores for the entity assets, a risk score median determined based on the one or more risk scores for the entity assets, and/or the like.

Optionally, as shown by operation 318, the apparatus 200 includes means, such as processor 202, memory 204, communications hardware 206, insight circuitry 212, and/or the like, for generating one or more global insights. Each global insight may be indicative of an inferred cause for the global risk score associated with the entity. In some embodiments, the insight circuitry 212 may determine the one or more global insights for the entity based on the one or more global risk scores associated with the entity.

Similar to operation 314 of FIG. 3, the insight circuitry 212 may use an insight inference framework to generate the one or more global insights. Here, the insight circuitry 212 may additionally provide the one or more global risk scores as well as the one or more risk score values determined for each entity asset to the insight inference framework. Thus, the one or more inference models may be configured to determine the one or more contributing factors that resulted in a global risk score for a given risk score type. For example, the one or more inference models may determine that the entity had a large number of entity assets with a comparatively low entity transitional nature risk score as compared to the mean entity transitional nature risk score and thus the entity transitional nature risk score had a large variance. The inference model may thus determine that these entity assets were contributing factors that resulted in a lowered global entity transitional nature risk score for the entity. The one or more insight generation models may then generate the one or more global insights indicative that these particular entity assets were associated with relatively low entity transitional nature risk scores as compared to the mean entity transitional nature risk score and thus, the global entity transitional nature risk score was lowered.

Optionally, as shown by operation 320, the apparatus 200 includes means, such as processor 202, memory 204, communications hardware 206, entity analysis circuitry 208, risk scoring circuitry 210, insight circuitry 212, and/or the like, for determining an entity risk ranking. In some embodiments, the insight report request may indicate a request for the insight report to include an entity risk ranking for the entity. The entity risk ranking may be determined for one or more risk categories. For example, a risk category may correspond to an entity physical nature risk categoryan entity transitional nature risk category, and/or a global risk score category (e.g., entity physical nature global risk category, an entity transitional nature global risk category). The insight circuitry 212 may determine an entity risk ranking for the entity in one or more of the risk categories based on a comparison of associated entity asset risk scores and/or entity global risk scores as compared to other entity asset risk scores and/or global risk scores for one or more comparative entities. The one or more comparative entities the entity may be compared to may correspond to an entity that shares at least one common industry category with the entity. For example, the entity may be associated with an oil industry category and gas industry category such that the entity offers oil and gas services and/or products. Thus, the one or more comparative entities may include other companies or organizations that offer oil and/or gas services and/or products. An entity ranking may be indicative of a position, percentile, and/or the like determined for the entity based on the corresponding entity asset risk scores and/or global risk scores.

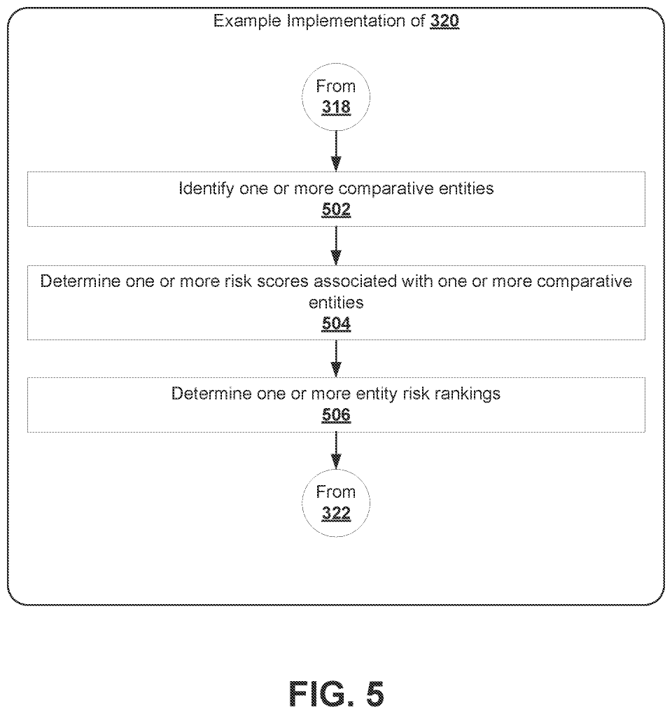

In some embodiments, operation 320 may be performed in accordance with the operations described by FIG. 5. Turning now to FIG. 5, example operations are shown for determining an entity risk ranking.

As shown by operation 502, the apparatus 200 includes means, such as processor 202, memory 204, communications hardware 206, entity analysis circuitry 208, and/or the like, for identifying one or more comparative entities. An entity analysis circuitry 208 may identify one or more comparative entities that will be included in the risk ranking. As described above, the one or more comparative entities may correspond to entities (e.g., companies, organization, etc.) that share at least one common industry category with the entity. In some embodiments, the entity analysis circuitry 208 may determine industry categories for an entity based on the products and/or services offered by the entity. In particular, the entity analysis circuitry 208 may be configured with one or more candidate industry categories that are each associated with a set of qualifying criteria. The qualifying criteria may define a set of requirements which an entity must satisfy in order to be associated with the industry category. By way of continuing example, an oil industry category may require an entity to offer oil products and/or services.

The entity analysis circuitry 208 may associate the one or more determined industry categories for a given entity with an entity identified within the entity look-up table. As such, the entity analysis circuitry 208 may determine the industry categories for a given entity using the entity look-up table. The entity analysis circuitry 208 may then use the entity look-up table to determine one or more industry categories for the given entity and determine the one or more comparative entities by determining which entities are also associated with at least one industry category that is the same as the given entity.

As shown by operation 504, the apparatus 200 includes means, such as processor 202, memory 204, communications hardware 206, risk scoring circuitry 210, and/or the like for determining one or more risk scores associated with the one or more comparative entities. Additionally, the risk scoring circuitry 210 may determine or otherwise identify one or more risk scores for each of the one or more comparative entities. In some embodiments, the risk scoring circuitry 210 may determine one or more risk scores for each comparative entity substantially similarly to operation 308. Alternatively, the risk scoring circuitry 210 may determine the one or more risk scores for each comparative entity using the entity look-up table. That is, an insight report may have previously been generated for a comparative entity such that the one or more risk scores determined while generating the insight report may be stored in the entity look-up table and associated with the corresponding entity identifier. As such, the risk scoring circuitry 210 may use the entity look-up table to determine one or more risk scores for a given comparative entity. In some embodiments, the risk scoring circuitry 212 may determine one or more global risk scores for each comparative entity.

As shown by operation 506, the apparatus 200 includes means, such as processor 202, memory 204, communications hardware 206, insight circuitry 212, and/or the like for determining an entity risk ranking. Once the one or more risk scores are determined for the one or more comparative entities, the insight circuitry 212 may determine an entity risk ranking for the entity. In some embodiments, the insight circuitry 212 may determine an entity risk ranking for each risk score type based on the associated risk scores for the entity and the one or more comparative entities.

In some embodiments, the insight circuitry 212 may use a global risk score for the entity and the one or more comparative entities. The global risk may provide a metric determined at the entity-level as opposed to the individual entity asset level and thus, allow for streamlined comparison between various entities. Thus, the insight circuitry 212 may determine the entity risk ranking for the entity by directly comparing the one or more global risk scores for a particular risk score type to the global risk scores of the comparative entities. For example, the entity may have a global entity physical nature risk score that is the second lowest risk score out of 100 entities (e.g., 99 comparative entities). Thus, the risk ranking for entity may be two, indicating that the entity performed better 98 comparative entities and performing worse than 1 comparative entity.

In some embodiments, the insight circuitry 212 may use the one or more risk scores determined for each entity asset of a respective entity. In some embodiments, the insight circuitry 212 may perform one or more mathematical operations on the one or more risk scores to allow for direct comparison between entities. For example, the insight circuitry 212 may average the one or more risk scores of all entity assets of an entity for a particular risk score type and use the average risk score to determine a risk ranking of the entity. As another example, the insight circuitry 212 may determine the entity asset with the maximum and/or minimum risk score for a given risk score type and use the maximum and/or minimum risk score to determine the risk ranking.

Returning now to FIG. 3, as shown by operation 322, the apparatus 200 includes means, such as processor 202, memory 204, communications hardware 206, insight circuitry 212, and/or the like, for generating the insight report for the entity. Once the insight circuitry 212 has generated the one or more insights, the insight circuitry 212 may generate the insight report. The insight report may include the one or more insights determined in operation 314. In some embodiments, the insight report may further include an indication of the one or more entity assets as well as entity asset information (e.g., an entity asset type, associated geographic location, surrounding environment, an entity policy management set for the entity asset, etc.). Additionally, the insight report may include the one or more risk scores determined for each entity assets and the one or more risk heat maps. In some embodiments, the insight report may further include the one or more global risk scores and/or global insights determined for the entity. The insight report may further include one or more entity risk rankings determined for the entity. The particular content included in the insight report may be indicated in the insight report request received in operation 302. Additional content may be included in the insight report, such as one or more recommended policy sets, an implementation service offer, a future entity asset recommendation, and/or a scenario response, as described in further detail below.

The insight circuitry 212 may generate the insight report in any suitable format. For example, the insight report may be formatted as an electronic document. An electronic document may include file formats, such as an email, a portable document file, an image file, a comma separated value file, an extensible markup language file, a text file, a spreadsheet file, and/or the like. In some embodiments, the insight report may be a website page or code that is accessible to an authorized end-user. In some embodiments, an authorized end-user may be a user with credentials that are associated with the entity identifier of the corresponding entity. In some embodiments, the entity look-up table may further include authorized user credentials for users authorized to view the insight report for the corresponding entity. In some embodiments, the insight report may be formatted as a physical file. For example, the insight circuitry 212 may transform an electronic file to a physical file such as by printing the electronic file to generate the insight report.

As shown by operation 324, the apparatus 200 includes means, such as processor 202, memory 204, communications hardware 206, and/or the like, for providing the insight report for the entity. Once the insight circuitry 212 has generated the insight report, the insight report may be provided to one or more users via one or more devices (e.g., entity device 106A-106N or third-party device 108A-108N). The insight report may be provided to the device which provided the insight report request as well as additional devices indicated by the insight report request. In some embodiments, the insight report may also be stored in an associated memory, such as memory 204 and/or entity data repository 110. In some embodiments, the insight report may be stored in the entity look-up table and associated with the appropriate entity identifier.

The manner in which the insight report is provided may be dependent upon the format of the insight report. For example, insight reports formatted as a portable document file, an image file, a comma separated value file, an extensible markup language file, a text file, a spreadsheet file, and/or the like may be provided in any suitable manner, such as by using a file transfer service, via email, upload onto removable hardware, etc. Links to the file transfer service and/or email may be provided to the one or more devices (e.g., entity device 106A-106N or third-party device 108A-108N). In an instance in which the insight report is formatted as a website page or code that is accessible to an authorized end-user, a link to website may be provided to the one or more devices (e.g., entity device 106A-106N or third-party device 108A-108N). In an instance in which the insight report is formatted as a website code that is accessible to an authorized end-user, the content may be provided to a data repository (e.g., entity data repository 110) and may be used by the insight circuitry 212. In an instance in which the insight report is a physical file, the insight report may be sent and/or delivered to one or more addresses associated with the entity.

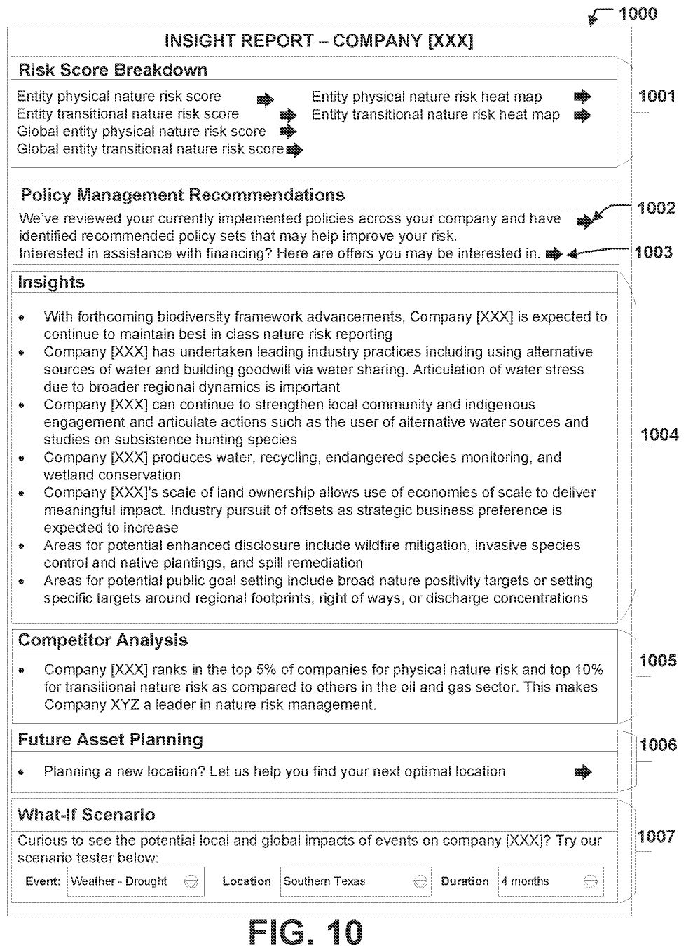

Turning to FIG. 10, a graphical user interface (GUI) is provided that illustrates an example insight report. As noted previously, a user may interact with the insight analysis system 102 by directly engaging with communications hardware 206 of an apparatus 200. In such an embodiment, the GUI shown in FIG. 10 may be displayed to a user by the apparatus 200. Alternatively, a user may interact with the insight analysis system 102 using a separate user device (e.g., any of entity devices 106A through 106N, as shown in FIG. 1), which may communicate with the insight analysis system 102 via communications network 104. In such an embodiment, the GUI shown in FIG. 10 may be displayed to the user by the corresponding user device.

As shown by FIG. 10, the insight report 1000 may provide the user with an indication of a risk score breakdown 1001. The risk score breakdown 1001 may include individual risk scores for a given risk score type, such as entity physical nature risk scores entity transitional nature risk scores, and/or a global entity physical nature risk score and/or a global entity transitional nature risk score. Additionally, the risk score breakdown 1001 may include one or more risk heat maps.

Additionally, the insight report 1000 may include a one or more recommended policy sets 1002 determined for one or more entity assets as well as one or more implementation service offers 1003 for the entity. The insight report 1000 may further include an insight summary 1004 which includes one or more insights determined for the entity assets and/or global insights determined for the entity. The insight report 1000 may further include a competitor analysis 1005 which includes the one or more entity risk rankings determined for the entity.

In some embodiments, the insight report 1000 may further include a future entity asset user input 1006 that may be interacted with by the user to result in a future entity asset request that includes indication of a future entity asset being received by the apparatus 200. The future entity asset user input 1006 may be prompt the user for responses to one or more questions, such as a future entity asset type and/or desired locations for the future entity asset.

In some embodiments, the insight report 1000 may further include a scenario request user input 1007 that may be interacted with by the user to result in a scenario request being received by the apparatus 200. The scenario request user input 1007 may be prompt the user for responses to one or more questions, such as scenario type, a scenario location, a scenario duration, etc.

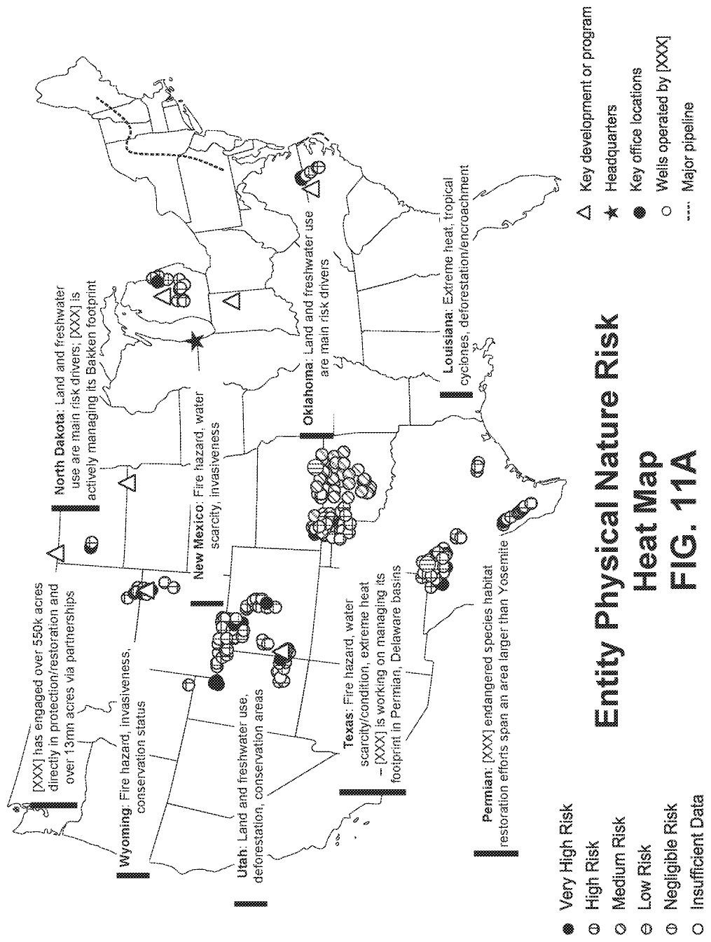

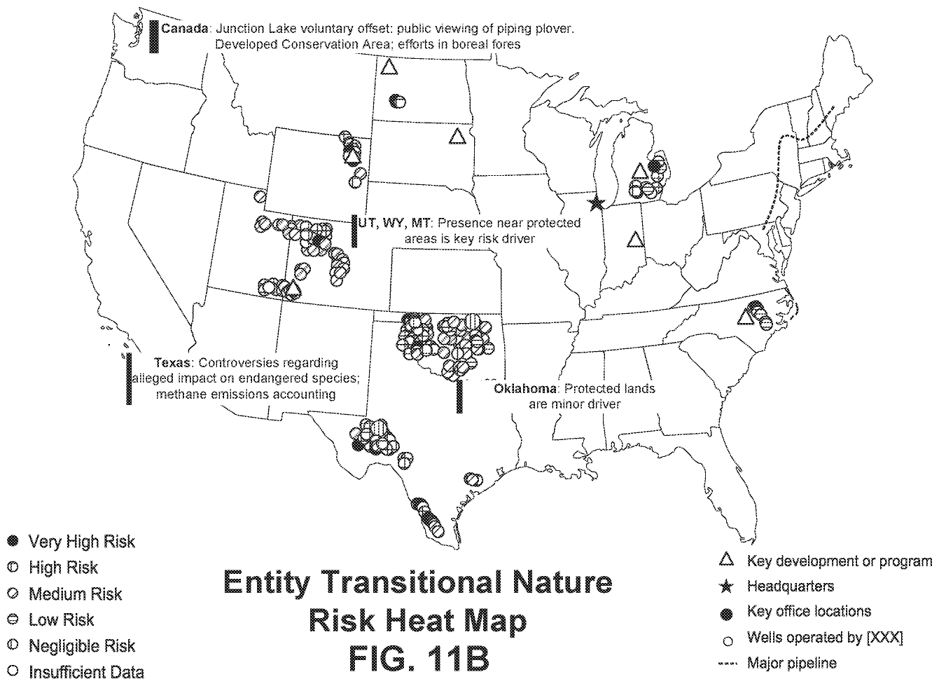

Turning to FIGS. 11A-11B, a GUI is provided that illustrate example generated risk heat maps. As noted previously, a user may interact with the insight analysis system 102 by directly engaging with communications hardware 206 of an apparatus 200. In such an embodiment, the GUI shown in FIGS. 11A-11B may be displayed to a user by the apparatus 200. Alternatively, a user may interact with the insight analysis system 102 using a separate user device (e.g., any of entity devices 106A through 106N, as shown in FIG. 1), which may communicate with the insight analysis system 102 via communications network 104. In such an embodiment, the GUI shown in FIGS. 11A-11B may be displayed to the user by the corresponding user device.

As shown by FIGS. 11A-11B, a risk heat map may provide the user with a visual indication of the various risk scores determined for the entity assets as well as showcase the locations of the entity assets. In particular, FIG. 11A depicts a risk heat map representative of entity physical nature risk scores determined for various entity assets, and FIG. 11B depicts a risk heat map representative of entity transitional nature risk scores determined for various entity assets.

In some embodiments, as shown by FIGS. 11A-11B, the one or more insights determined for various entity assets may be displayed on the one or more risk heat maps. In some embodiments, the one or more risk heat maps are intractable such that a user may interact with (e.g., scroll over, touch, click, etc.) a given entity asset to learn more about the particular entity asset. For example, interacting with a particular entity asset within the risk heat map may cause display of the one or more risk scores associated with the entity asset, the type of entity asset, the associated geographic area of the entity asset, the one or more insights determined for the entity asset, the entity policy management set for the entity asset, a recommended policy set for the entity asset, associated implantation service offers, an entity asset type requirement set, etc.

### Providing a Recommended Policy Set

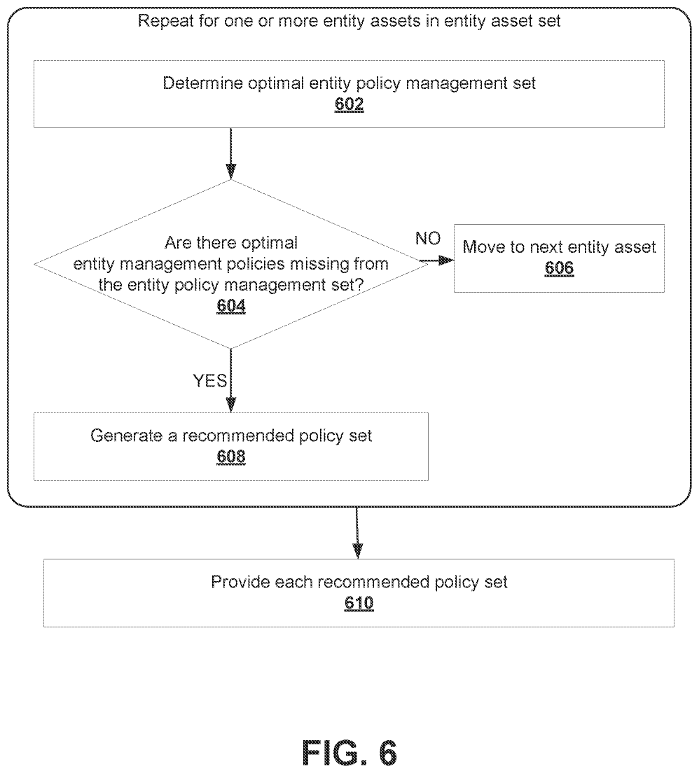

Turning now to FIG. 6, example operations are shown for generating a recommended policy set for one or more entity assets. In some embodiments, a request for generating a recommended policy set may be indicated by the insight report request received in operation 302. For example, the insight report request may indicate that a user or entity associated with the insight report request has additionally requested that one or more recommended policy sets be generated. Alternatively, communications hardware 206 may receive a separate recommended policy set request from an entity, such as via entity devices 106A-106N or third-party devices 108A-108N. Thus, apparatus 200 may perform the operations of FIG. 6, as described below, to provide the requesting entity one or more recommended policy sets. The recommended policy sets may be used by the entity to aid with identifying existing entity management policies used by various entity assets that may be improved and further, may provide insight into how these particular entity management policies may be improved, thus removing the manual burden from users to evaluate entity management policies.

Additionally, the recommended policy set is generated for specific entity assets such that considerations of the surrounding environment in which the entity asset operates within are considered. Thus, the recommended policy set includes optimal entity management policies that are determined based on the particular environment the specific entity asset operates within. Thus, the recommended policy set includes one or more optimal entity management policies that are determined based on the specific considerations of the operating environment in addition to the policies of the entity asset type. Therefore, the recommended policy set provides an improvement over traditional, manual methods of updating entity management policies as these traditional manual policies fail to consider the highly localized requirements of each entity asset and the surrounding environment.

Operations 602-608 may be performed for each entity asset in the entity asset set. As such, each entity asset in the entity asset set may be individually evaluated to determine whether the associated entity policy management set is optimized for the entity asset. It will be appreciated that although operations 602-608 may be performed for each entity asset, in some embodiments, a recommended policy set may be determined for two or more entity assets simultaneously, such as by using parallel processing. As such, the computational run-time associated with evaluating an entity asset and determining whether to generate a recommended policy set for said entity asset may be reduced. This may allow for high-performance scaling of the process such that a large number of entity assets may be feasibly generated within a desired time frame.

As shown by operation 602, the apparatus 200 includes means, such as processor 202, memory 204, communications hardware 206, risk scoring circuitry 210, entity policy identification circuitry 214, and/or the like, for determining an optimal entity policy management set. An optimal entity policy management set may include one or more optimal entity management policies. An optimal entity management policy may be an operating rule for an entity asset that may result in a maximum or optimal risk score for the entity asset. In particular, an entity asset may be associated with a geographic location and surrounding environment that has certain characteristics, such as certain nature and/or water sensitivities. The entity asset may have dependencies and/or impacts on the state of the nature and/or water due to its operations. For example, an entity asset may require access to a water source and an associated geographic area or surrounding environment may have multiple water sources. While access to a water source may be a mandatory requirement for the entity asset, the use of different water sources may affect the one or more risk scores determined for the entity asset. By way of particular example, one water source may be a known primary water source for local farmers such that the use of this water source by the entity asset may adversely affect a risk score. As another example, the entity asset may improve one or more risk scores by implementing water conservation efforts, enforcing strict spill/leak prevention policies, funding water treatment facilities, etc.

In practice, in some embodiments, the entity policy identification circuitry 214 may determine one or more candidate optimal entity management policies for a given entity asset that is associated with a particular geographic location. In some embodiments, the entity policy identification circuitry 214 may use an optimal entity management policy model, which may be configured to process the entity asset and associated geographic region and generate one or more candidate optimal entity management policies. In some embodiments, the optimal entity management policy model may be a machine learning model or rules-based model. In particular, the optimal entity management policy model may be a LLM or neural network that may be configured to process the entity asset to generate the one or more candidate optimal entity management policies. In some embodiments, the optimal entity management policy model may use the asset type requirement set associated with the entity asset to determine the one or more entity asset requirements and generate one or more candidate optimal entity management policies based on these requirements.

In some embodiments, once the entity policy identification circuitry 214 has generated the one or more candidate optimal entity management policies for the entity asset, these candidate optimal entity management policies may be provided to risk scoring circuitry 210 along with the entity asset and associated geographic region. The risk scoring circuitry 210 may then determine one or more candidate risk scores for the entity asset based on the one or more provided candidate optimal entity management policies and using one or more risk scoring models, substantially similarly to the operations described above in operation 308 of FIG. 3.

The process of generating one or more candidate optimal entity management policies and determining one or more candidate risk scores may be repeated a threshold number of times. After this process has been repeated the threshold number of times, the entity policy identification circuitry 214 may select the best performing one or more candidate optimal entity management policies as the optimal entity management policies. This selection may be made based on a comparison of the one or more candidate risk scores associated with various combinations of the one or more candidate optimal entity management policies.

As shown by operation 604, the apparatus 200 includes means, such as processor 202, memory 204, communications hardware 206, entity policy identification circuitry 214, and/or the like, for determining whether one or more optimal entity management policies from the optimal entity policy management set are missing from the entity policy management set for an entity asset. Once the entity policy identification circuitry 214 has determined the optimal entity policy management set, the entity policy identification circuitry 214 may further determine whether each of the one or more optimal entity management policies included in the optimal entity policy management set are currently included in the entity policy management set associated with the entity asset.

In some embodiments, the entity policy identification circuitry 214 may use a similarity model to determine whether an optimal entity management policy is included in the entity policy management set. The similarity model may be a machine learning or rules-based model configured to use NLP or other language processing techniques to determine a similarity score for a given optimal entity management policy and the one or more entity management policies. A generated similarity score may be indicative of a similarity in overall context and/or semantic meaning of the characters, sentences, paragraphs, etc. between the optimal entity management policy and a given entity management policy. In an instance in which a similarity score for a given optimal entity management policy satisfies a similarity score threshold, the optimal entity management policy may be determined to be included in the entity policy management set. In an instance in which a similarity score for a given optimal entity management policy fails to satisfy a similarity score threshold, the optimal entity management policy may be determined to be missing from the entity policy management set. A similarity score may allow for variations between the exact terms and/or phrases of a given entity management policy and an optimal entity management policy while still identifying whether the compared policies are conceptually the same or sufficiently similar.

In an instance in which each optimal entity management policy from the optimal entity policy management set is included in the entity policy management set for the entity asset, the process proceeds to operation 606. As shown by operation 606, the apparatus 200 includes means, such as processor 202, memory 204, entity policy identification circuitry 214, and/or the like, for moving to the next entity asset in the entity asset set. In an instance in which each optimal entity management policy from the optimal entity policy management set is included in the entity policy management set for the entity asset, this is indicative that the current entity policy management set is the optimal entity management set. In some embodiments, the entity policy identification circuitry 214 may further provide an indication that the current entity policy management set is the optimal entity management set for the given entity asset.

In an instance in which one or more optimal entity management policies from the optimal entity policy management set are missing from the entity policy management set for the entity asset, the process proceeds to operation 608. As shown by operation 608, the apparatus 200 includes means, such as processor 202, memory 204, entity policy identification circuitry 214, and/or the like, for generating a recommended policy set. In an instance in which one or more optimal entity management policies from the optimal entity policy management set are missing from the entity policy management set for the entity asset, this is indicative that the current entity policy management set is not optimized. Thus, the entity policy identification circuitry 214 may generate the recommended policy set for the entity asset. The recommended policy set may include the one or more optimal entity management policies determined to be missing from the entity policy management set, as determined in operation 604.

As shown by operation 610, the apparatus 200 includes means, such as processor 202, memory 204, communications hardware 206, and/or the like, for providing each recommended policy set. In some embodiments, the recommended policy set may be included in the insight report. For example, if the insight report request was indicative that a user or entity associated with the insight report request has additionally requested that one or more recommended policy sets be generated, each recommended policy set may be included in the insight report. Alternatively, communications hardware 206 may have receive a separate recommended policy set request from an entity, such as via entity devices 106A-106N or third-party devices 108A-108N. In this instance, the communications hardware 206 may provide each recommended policy set in a separate recommended policy set response.

### Providing an Implementation Service Offer Message

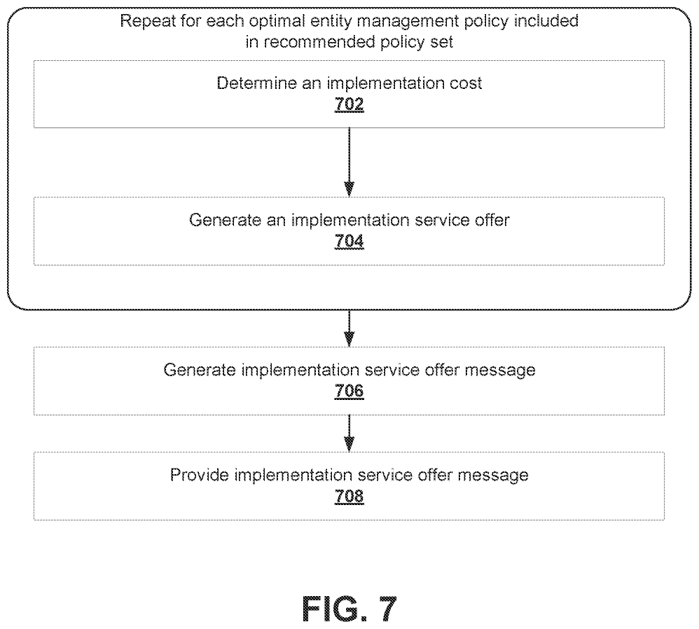

Turning now to FIG. 7, example operations are shown for generating an implementation service offer message. In some embodiments, the insight report request may indicate that a user or entity associated with the insight report request has additionally requested that one or more recommended policy sets be generated and has also opted into service offers. Alternatively, communications hardware 206 may receive a separate implementation service offer request from an entity, such as via entity devices 106A-106N or third-party devices 108A-108N. Thus, apparatus 200 may perform the operations of FIG. 7, as described below, to provide the requesting entity an implementation service offer message. The generated implementation service offer message may include one or more implementation service offers for the entity. An implementation service offer may offer financial assistance or other resource assistance for the entity to aid the entity with implementing one or more changes, updates, modifications, etc. to the existing entity management policies. Thus, the implementation service offers included in the implementation service offer may provide the entity with the resources required to implement the one or more optimal entity management policies.

Operations 702-704 may be performed for each optimal entity management policy included in a recommended policy set for a given entity asset. As such, each optimal entity management policy in the recommended policy set may be individually evaluated to determine an implementation service offer. It will be appreciated that although operations 702-704 may be performed for each optimal entity management policy, in some embodiments, an implementation service offer may be generated for two or more optimal entity management policies simultaneously, such as by using parallel processing. As such, the computational run-time associated with generating an implantation service offer may be reduced. This may allow for high-performance scaling of the process such that a large number of implementation service offers may be feasibly generated within a desired time frame.

As shown by operation 702, the apparatus 200 includes means, such as processor 202, memory 204, communications hardware 206, entity improvement circuitry 216, and/or the like, for determining an implementation cost for an optimal entity management policy. Once the entity policy identification circuitry 214 has generated a recommended policy set for an entity asset, which includes one or more optimal entity management policies, the entity improvement circuitry 216 may evaluate each optimal entity management policy to determine an implementation cost for said optimal entity management policy. An implementation cost is an estimate of the financial resources required for the entity asset to implement the optimal entity management policy.

In some embodiments, the entity improvement circuitry 216 may use an estimate model to determine an implementation cost. The estimate model may be a machine learning model or rules based model that is configured to process the optimal entity management policy, the entity asset and associated geographic area, and optionally the current entity management policy for the entity asset to determine the implementation cost. In particular, the estimate model may be neural network. In some embodiments, the estimate model may be configured to use clustering techniques to determine a similarity score between the optimal entity management policy and one or more historical optimal entity management policies based on the optimal entity management policy content as well as the associated entity asset and optionally, the current entity management policy. The historical optimal entity management policies may each be associated with a known implementation cost. Thus, the estimate model may be configured to determine the implementation cost for the optimal entity management policy based on a similarity between the optimal entity management policy and the historical optimal entity management policy and its associated known implementation cost.

As shown by operation 704, the apparatus 200 includes means, such as processor 202, memory 204, communications hardware 206, entity improvement circuitry 216, and/or the like, for generating an implementation service offer for an optimal entity management policy. Once the entity improvement circuitry 216 has determined the implementation cost for the optimal entity management policy, the entity improvement circuitry 216 may further generate an implementation service offer. An implementation service offer may include a financial instrument offer with a particular value. For example, a financial instrument offer may be a fixed-rate loan, an adjustable-rate loan, a construction loan, a refinancing loan, etc. The value of the financial instrument offer may cover at least a portion of the implementation cost determined in operation 702. In some embodiments, the entity improvement circuitry 216 may determine the financial instrument offer and/or value of the financial instrument offer based on currently available products or services offered by an entity associated with apparatus 200, which may be a financial institution. The currently available products or services may be associated with various qualifying criteria as well as financial limits such that the entity improvement circuitry 216 may evaluate the entity and/or entity asset to determine whether the entity or entity asset qualifies for a given financial product. Additionally, the entity improvement circuitry 216 may determine which products and/or services are associated with limits that cover the implementation cost. In some embodiments, the entity improvement circuitry 216 may include each qualifying financial instrument in the implementation service offer. In some embodiments, the entity improvement circuitry 216 may provide an indication of each qualifying financial instrument to an authorized user associated with apparatus 200 and receive feedback from the authorized user indicative of which financial instruments to include in the implementation service offer. In some embodiments, the entity or entity asset may not qualify for any financial products such that the implementation service offer is not generated for the particular optimal entity management policy.

As shown by operation 706, the apparatus 200 includes means, such as processor 202, memory 204, communications hardware 206, entity improvement circuitry 216, and/or the like, for generating an implementation service offer message. Once the implementation service offers for the qualifying optimal entity management policies are generated, the entity improvement circuitry 216 may generate an implementations service offer message. The implementation service offer message may include each generated implementation service offer as well as an indication of the optimal entity management policy and/or entity asset to which implementation service offer corresponds.

As shown by operation 708, the apparatus 200 includes means, such as processor 202, memory 204, communications hardware 206, and/or the like, for providing the implementation service offer message. In some embodiments, the implementation service offer message may be included in the insight report. For example, if the insight report request was indicative that a user or entity associated with the insight report request has additionally requested that one or more recommended policy sets be generated and has opted into service offers, the implementation service offer message may be included in the insight report. Alternatively, communications hardware 206 may have receive a separate implementation service offer request from an entity, such as via entity devices 106A-106N or third-party devices 108A-108N. In this instance, the communications hardware 206 may provide the implementation service offer message in a separate implementation service offer response.

### Providing a Future Entity Asset Recommendation Response

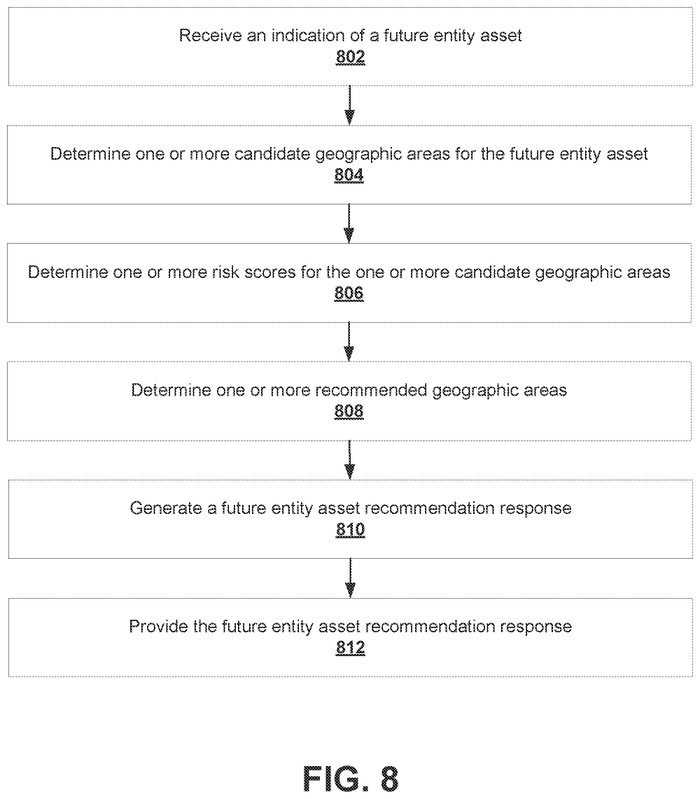

Turning now to FIG. 8, example operations are shown for providing a future entity asset recommendation response. In some embodiments, the insight report request may indicate that a user or entity associated with the insight report request has additionally requested a future entity asset recommendation and has provided an indication of a future entity asset in the insight report request. In some embodiments, the insight report may include one or more user inputs that the user may interact with to cause a future entity asset request with an indication of future entity asset to be received. Alternatively, communications hardware 206 may receive a separate future entity asset recommendation request from an entity, such as via entity devices 106A-106N or third-party devices 108A-108N. Thus, apparatus 200 may perform the operations of FIG. 8, as described below, to provide the requesting entity a future entity asset recommendation. The future entity asset recommendation may provide one or more recommended geographic areas to place a future entity asset of a particular entity asset type. The one or more recommended geographic areas may be geographic areas associated with one or more relatively low risk scores for the entity asset as compared to other geographic areas. Thus, the entity may automatically be provided with optimal placement locations for a future entity asset without having to manually search and evaluate these locations, as is conventionally done.

As shown by operation 802, the apparatus 200 includes means, such as processor 202, memory 204, communications hardware 206, and/or the like, for receiving an indication of a future entity asset. In some embodiments, communications hardware 206 may receive an indication of a future entity asset in the insight report request or in response to providing the insight report. Alternatively, the communications hardware 206 may receive a separate future entity asset recommendation request. Each of these communications may be indicative of a future entity asset. Regardless of how the communications hardware 206 receives the indication of a future entity asset, the indication of a future entity asset may further include an entity asset type for the future entity asset. Additionally, in some embodiments, the indication of the future entity asset may further include one or more desired locations that are indicative of geographic areas of interest to place the future entity asset.

As shown by operation 804, the apparatus 200 includes means, such as processor 202, memory 204, communications hardware 206, risk scoring circuitry 210, and/or the like, for determining one or more candidate geographic areas for the future entity asset. The risk scoring circuitry 210 may determine one or more candidate geographic areas for the future entity asset based on an availability of real-estate in various geographic areas (e.g., real estate properties and/or plots of land for sale) as well as surrounding environments of the geographic areas. In particular, each entity asset type may be associated with an entity asset type requirement set as described above. As such, the risk scoring circuitry 210 may evaluate whether available real-estate satisfies the one or more entity asset type requirements. In an instance in which the risk scoring circuitry 210 determines the available real-estate satisfies the one or more entity asset type requirements, the geographic area associated with the available real-estate is determined to be a candidate geographic area. In some embodiments, in an instance in which the indication of the future entity asset includes the one or more desired locations, the risk scoring circuitry 210 may restrict determining candidate geographic areas that are located within one of the desired locations.

As shown by operation 806, the apparatus 200 includes means, such as processor 202, memory 204, communications hardware 206, risk scoring circuitry 210, and/or the like, for determining one or more risk scores for the one or more candidate geographic areas. The risk scoring circuitry 210 may determine or more risks scores for each of the one or more candidate geographic areas substantially similarly to operation 308 of FIG. 3. As such, each candidate geographic area may be associated with one or more risk scores for the future entity asset.

As shown by operation 808, the apparatus 200 includes means, such as processor 202, memory 204, communications hardware 206, risk scoring circuitry 210, and/or the like, for determining one or more recommended geographic areas. Once the risk scoring circuitry 210 has determined the one or more risk scores for the future entity asset, the risk scoring circuitry 210 may determine one or more recommended geographic areas for the future entity asset based on the associated one or more risk scores. In some embodiments, the risk scoring circuitry 210 may determine whether the one or more risk scores for a candidate geographic area satisfy a risk scoring threshold associated with a particular risk score type. In an instance in which the candidate geographic area is associated with one or more risk scores which each satisfy a corresponding risk scoring threshold, the risk scoring circuitry 210 may determine the candidate geographic area to be a recommended geographic area. In some embodiments, the risk scoring circuitry 210 may determine the top-performing n candidate geographic areas and these n candidate geographic areas may be determined as the one or more recommended geographic areas.

As shown by operation 810, the apparatus 200 includes means, such as processor 202, memory 204, communications hardware 206, risk scoring circuitry 210, and/or the like, for generating a future entity asset recommendation response. The future entity asset recommendation response may include the one or more recommended geographic areas. In some embodiments, the future entity asset recommendation may further include the one or more risk scores associated with each recommended geographic area.

As shown by operation 812, the apparatus 200 includes means, such as processor 202, memory 204, communications hardware 206, and/or the like, for providing a future entity asset recommendation response. In some embodiments, the future entity asset recommendation response may be included in the insight report. For example, if the insight report request was indicative that a user or entity associated with the insight report request had provided an indication of a future entity asset, the insight report may include the future entity asset recommendation. Alternatively, communications hardware 206 may receive a separate future entity asset recommendation request, such as via entity devices 106A-106N or third-party devices 108A-108N. In this instance, the communications hardware 206 may provide the one or more recommended geographic areas in a separate future entity asset recommendation response.

### Providing a Scenario Response

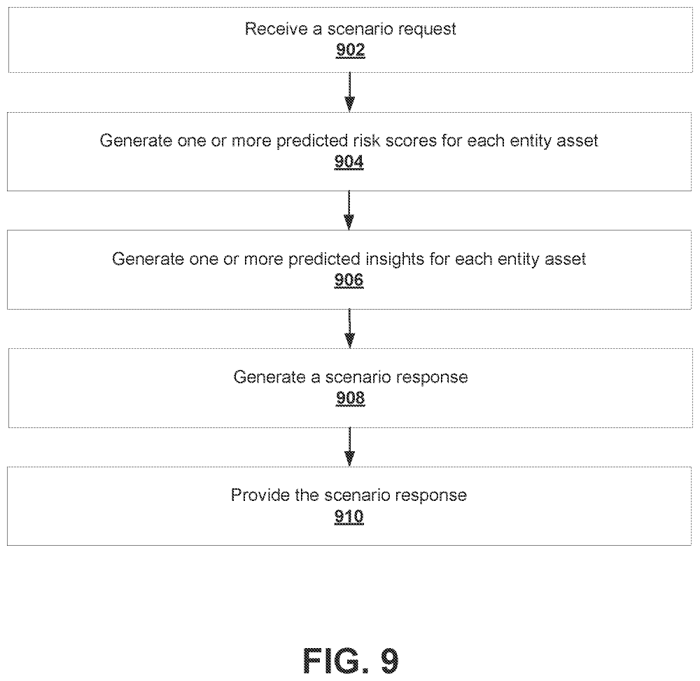

Turning now to FIG. 9, example operations are shown for providing a scenario response. In some embodiments, the insight report request may indicate that a user or entity associated with the insight report request has additionally provided a scenario request. In some embodiments, the insight report may include one or more user inputs that the user may interact with to cause a scenario request to be received. Alternatively, communications hardware 206 may receive a separate scenario request from an entity, such as via entity devices 106A-106N or third-party devices 108A-108N. Thus, apparatus 200 may perform the operations of FIG. 9, as described below, to provide the requesting entity a scenario response. The scenario response may provide the entity with one or more insights into how various changes captured by a scenario in a scenario request may affect one or more entity assets of the entity. This may aid the entity with identifying weak points of individual entity assets as well as the entity as a whole and thus allow the entity to begin contingency planning prior to encountering potential adverse impacts caused by such a scenario playing out. This may be particularly beneficial for entities that are particularly sensitive to environmental changes.

As shown by operation 902, the apparatus 200 includes means, such as processor 202, memory 204, communications hardware 206, and/or the like, for receiving a scenario request. A scenario request may include a scenario type and a scenario parameter set. The scenario type may be indicative of a type of scenario desired, such as a particular weather event (e.g., drought, flood, hurricane, tornado, etc.), changes in sea level, changes in conservation status of flora or fauna (e.g., vulnerable, threatened, endangered, critically endangered, etc.), and/or the like. The scenario parameter set may include one or more scenario parameters that provide additional details for the scenario. For example, the one or more scenario parameters may include a location of the scenario, a duration of the scenario, and/or the like.

As shown by operation 904, the apparatus 200 includes means, such as processor 202, memory 204, communications hardware 206, risk scoring circuitry 210, and/or the like, for generating one or more predicted risk scores for each entity asset. The risk scoring circuitry 210 may provide the scenario type and scenario parameter set to a simulation model. The simulation model may be a machine learning model that is configured to process the scenario type and scenario parameter set and predicts one or more environmental changes based on the scenario type and scenario parameter set. In some embodiments, the scenario model may be a neural network that is configured to determine patterns within historical environmental data. In particular, a scenario model may trained using historical environmental data that is labelled with one or more scenario types. Thus, the scenario model may be configured to infer patterns and changes that result from the occurrence of an event of given scenario type.

The risk scoring circuitry 210 may use the scenario model to determine one or environmental changes to one or more geographic regions corresponding to geographic regions associated with an entity asset. The risk scoring circuitry 210 may then provide the one or more environmental changes along with the one or more entity assets for the entity to one or more risk scoring models. The risk scoring models may then be used to generate one or more predicted risk scores for each entity asset in a substantially similar manner as described in operation 308 of FIG. 3.

As shown by operation 906, the apparatus 200 includes means, such as processor 202, memory 204, communications hardware 206, insight circuitry 212, and/or the like, for generating one or more predicted insights for each entity asset. Once the risk scoring circuitry 210 has generated the one or more predicted risk scores, the insight circuitry 212 may process the one or more updated risk scores for each entity asset to determine one or more predicted insights for each entity asset. In some embodiments, the insight circuitry 212 may use the insight framework to generate the one or more predicted insights in a substantially similar manner as described in operation 314 of FIG. 3. In some embodiments, the insight circuitry 212 may provide the insight framework the one or more updated risk scores determined for each entity asset, the one or more current risk scores for each entity asset, the scenario type, and scenario parameter set such that the one or more inference models of the insight inference framework may be provided additional context for determining the one or more contributing factors for the risk scores and the one or more insight generation models may be provided context for generating the one or more predicted insights.

As shown by operation 908, the apparatus 200 includes means, such as processor 202, memory 204, communications hardware 206, risk scoring circuitry 210, insight circuitry 212, and/or the like, for generating a scenario response. The scenario response may include the one or more predicted insights and the one or more predicted risks scores for each entity asset. In some embodiments, the scenario response may further include the one or more risk scores currently determined for the entity asset such that a comparison may be made.

As shown by operation 910, the apparatus 200 includes means, such as processor 202, memory 204, communications hardware 206, risk scoring circuitry 210, and/or the like, for providing a scenario response. In some embodiments, the scenario response may be included in the insight report. For example, if the insight report request was indicative that a user or entity associated with the insight report request had provided a scenario request, the insight report may include the scenario response. Alternatively, communications hardware 206 may receive a separate scenario request, such as via entity devices 106A-106N or third-party devices 108A-108N. In this instance, the communications hardware 206 may provide the scenario response in a separate communication.

FIGS. 3-9 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide methods and apparatuses that enable improved methods for gauging various risks of entity assets and providing insights into these risks. In particular, example embodiments provide for the generation and provision of an insight report that may provide users with an indication of the various risk scores determined for the entity assets as well as the insights for each entity asset. As such, end users may review the insight report to gain a better understanding of the risk associated with the entity as a whole as well as the risk associated with each entity asset.

In particular, the insight report may include one or more risk scores for the entity assets, such as an entity physical nature risk score and/or an entity transitional nature risk score. Each risk score may be associated with its own set of evaluation criteria that is used to determine the particular risk score for each entity asset. Additionally, one or more global risk scores, such as a global entity physical nature risk score and/or a global entity transitional nature risk score may be determined for the entity. The insight report may include these risk scores as well as the one or more insights, which provide an explanation of an inferred cause for a risk score associated with the entity asset, and/or one or more global insights, which provide an explanation of an inferred cause for a global risk score associated with the entity. Additionally, the insight report may provide an entity risk ranking indicative of a relative ranking of the entity as compared to other comparable entities. Thus, the end users may be made aware of how the entity is performing relative to other, similar entities.

Example embodiments also allow for the generation of additional information regarding the entity and/or entity assets, such as recommended policy sets, implementation service offers, future entity asset responses, scenario responses, which may each provide additional insights into the entity as a whole as well as the individual entity assets that were not traditionally available. Thus, users may be provided with a current snap-shot of entity risk, opportunities to improve entity risk, and planning tools to allow for long-term planning of future entity developments.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for generating an insight report for an entity, the method comprising:
identifying, by entity analysis circuitry, an entity asset set for the entity, wherein (i) the entity asset set comprises one or more entity assets associated with the entity, (ii) each entity asset is associated with an entity asset type, and (iii) each entity asset is further associated with a geographic area;
determining, by risk scoring circuitry and based on a corresponding entity asset type and a corresponding geographic area, one or more risk scores for each entity asset included in the entity asset set;
generating, by insight circuitry and based on the one or more risk scores, one or more insights for each entity asset included in the entity asset set, wherein the each insight is indicative of an inferred cause for a risk score associated with the entity asset;
generating, by the insight circuitry, the insight report for the entity, wherein the insight report comprises the one or more insights; and
providing, by communications hardware, the insight report.

2. The method of claim 1, further comprising;
for one or more entity assets in the entity asset set:
determining, by entity policy identification circuitry, an entity policy management set, wherein (i) the entity policy management set comprises one or more entity management policies and (ii) each entity management policy is indicative of one or more operating rules that the entity asset follows,
wherein determining the one or more insights for the entity asset is further based on the entity policy management set.

3. The method of claim 2, further comprising:
for one or more entity assets in the entity asset set:
determining, by the entity policy identification circuitry and based on the geographic area associated with the entity asset, an optimal entity policy management set, wherein (i) the optimal entity policy management set comprises one or more optimal entity management policies and (ii) each optimal entity management policy is indicative of one or more operating rules determined to result in a maximum risk score for the entity asset,
identifying, by the entity policy identification circuitry and based on the entity policy management set and the optimal entity policy management set associated with the entity asset, one or more optimal entity management policies that are missing from the entity policy management set, and
in an instance in which one or more optimal entity management policies are identified, generating, by the entity policy identification circuitry, a recommended policy set, wherein (i) the recommended policy set comprises the one or more optimal entity management policies that were determined to not be included in the entity policy management set and (ii) the insight report further comprises the recommended policy set.

4. The method of claim 3, further comprising:
for one or more optimal entity management policies included in the recommended policy set:
determining, by entity improvement circuitry, an implementation cost estimate for the optimal entity management policy,
generating, by the entity improvement circuitry, an implementation service offer, wherein the implementation service offer comprises a financial instrument offer and a value of the financial instrument offer covers at least a portion of the implementation cost estimate, and
providing, by communications hardware, an implementation service offer message, wherein the implementation offer message comprises each generated implemented service offer for the one or more optimal entity management policies.

5. The method of claim 1, further comprising:
identifying, by the entity analysis circuitry, entity asset information from one or more entity data sources;
identifying, by the entity analysis circuitry, one or more candidate entity assets from the entity asset information;
determining, by the entity analysis circuitry, a geographic area associated with one or more of the one or more candidate entity assets; and
generating, by the entity analysis circuitry and based on the one or more identified candidate entity assets and corresponding determined geographic location, the entity asset set for the entity.

6. The method of claim 1, further comprising:
for one or more entity assets in the entity asset set:
receiving, by communications hardware, a resource consumption set, wherein the resource consumption set comprises one or more resource consumption metrics for the entity asset collected over a time frame,
wherein determining the one or more risk scores for the entity asset is based on the resource consumption set associated with the entity asset.

7. The method of claim 1, further comprising:
receiving, by the communications hardware, an indication of a future entity asset, wherein the future entity asset is associated with an entity asset type;
determining, by risk scoring circuitry and based on a corresponding entity asset type associated with the future entity asset, one or more candidate geographic areas for the future entity asset;
determining, by the risk scoring circuitry and based on the entity asset type associated with the future entity asset, one or more risk scores for the one or more candidate geographic areas;
determining, by the risk scoring circuitry and based on the one or more risk scores associated with the one or more candidate geographic areas, one or more recommended geographic areas; and
providing, by the communications hardware, a future entity asset recommendation response, wherein the future entity asset recommendation response comprises the one or more recommended geographic areas.

8. The method of claim 1, further comprising:
receiving, by the communications hardware, a scenario request, wherein the scenario request comprises a set a scenario type and a scenario parameter set;
generating, by risk scoring circuitry and based on a corresponding entity asset type, a corresponding geographic area, and the scenario request, one or more predicted risk scores for each entity asset included in the entity asset set;
generating, by insight circuitry and based on the one or more predicted risk scores, one or more predicted insights for each entity asset included in the entity asset set, wherein the each insight is indicative of an inferred cause for a predicted risk score associated with the entity asset; and
providing, by the communications hardware, a scenario response, wherein the scenario response comprises the one or more predicted insights.

9. The method of claim 1, further comprising:
determining, by the risk scoring circuitry and based on the one or more risk scores associated with the one or more entity assets, one or more global risk scores; and
generating, by the insight circuitry and based on the one or more global risk scores, one or more global insights for the entity, wherein the each global insight is indicative of an inferred cause for the global risk score associated with the entity.

10. The method of claim 1, wherein the one or more risk scores each correspond to a risk score type and a risk score type comprises a physical nature risk score or a transitional nature risk score.

11. The method of claim 1, further comprising:
identifying, by the entity analysis circuitry, one or more comparative entities, wherein the one or more identified comparative entities share at least one common industry category with the entity; and
determining, by the insight circuitry based on the one or more risk scores associated with the entity and one or more risk scores associated with the one or more comparative entities, an entity risk ranking, wherein the entity risk ranking is included in the insight report.

12. The method of claim 1, further comprising:
generating, by the risk scoring circuitry and based on the one or more risk scores, one or more risk heat maps, wherein (i) each risk heat map is associated with a risk score type and (ii) the insight report further comprises the one or more risk scores.

13. An apparatus for generating an insight report for an entity, the apparatus comprising:
entity analysis circuitry configured to:
identify an entity asset set for the entity, wherein (i) the entity asset set comprises one or more entity assets associated with the entity, (ii) each entity asset is associated with an entity asset type, and (iii) each entity asset is further associated with a geographic area;
risk scoring circuitry configured to:
determine, based on a corresponding entity asset type and a corresponding geographic area, one or more risk scores for each entity asset included in the entity asset set;
insight circuitry configured to:
generate, based on the one or more risk scores, one or more insights for each entity asset included in the entity asset set, wherein the each insight is indicative of an inferred cause for a risk score associated with the entity asset, and
generate the insight report for the entity, wherein the insight report comprises the one or more insights; and
communications hardware configured to:
provide the insight report.

14. The apparatus of claim 13, further comprising entity policy identification circuitry configured to:
for one or more entity assets in the entity asset set:
determine an entity policy management set, wherein (i) the entity policy management set comprises one or more entity management policies and (ii) each entity management policy is indicative of one or more operating rules that the entity asset follows,
wherein determining the one or more insights for the entity asset is further based on the entity policy management set.

15. The apparatus of claim 14, wherein the entity policy identification circuitry is further configured to:
for one or more entity assets in the entity asset set:
determine, based on the geographic area associated with the entity asset, an optimal entity policy management set, wherein (i) the optimal entity policy management set comprises one or more optimal entity management policies and (ii) each optimal entity management policy is indicative of one or more operating rules determined to result in a maximum risk score for the entity asset,
identify, based on the entity policy management set and the optimal entity policy management set associated with the entity asset, one or more optimal entity management policies that are missing from the entity policy management set, and
in an instance in which one or more optimal entity management policies are identified, generate a recommended policy set, wherein (i) the recommended policy set comprises the one or more optimal entity management policies that were determined to not be included in the entity policy management set and (ii) the insight report further comprises the recommended policy set.

16. The apparatus of claim 13, wherein the entity analysis circuitry is further configured to:
identify entity asset information from one or more entity data sources;
identify one or more candidate entity assets from the entity asset information;
determine a geographic area associated with one or more of the one or more candidate entity assets; and
generate, based on the one or more identified candidate entity assets and corresponding determined geographic location, the entity asset set for the entity.

17. The apparatus of claim 13, wherein the communications hardware is further configured to:
for one or more entity assets in the entity asset set:
receive a resource consumption set, wherein the resource consumption set comprises one or more resource consumption metrics for the entity asset collected over a time frame,
wherein determining the one or more risk scores for the entity asset is based on the resource consumption set associated with the entity asset.

18. The apparatus of claim 13, wherein the communications hardware is further configured to receive an indication of a future entity asset, wherein the future entity asset is associated with an entity asset type; and
wherein risk scoring circuitry is further configured to:
determine, based on a corresponding entity asset type associated with the future entity asset, one or more candidate geographic areas for the future entity asset,
determine, based on the entity asset type associated with the future entity asset, one or more risk scores for the one or more candidate geographic areas, and
determine, based on the one or more risk scores associated with the one or more candidate geographic areas, one or more recommended geographic areas; and
wherein the communications hardware is further configured to provide a future entity asset recommendation response, wherein the future entity asset recommendation response comprises the one or more recommended geographic areas.

19. The apparatus of claim 13, wherein the communications hardware is further configured to receive a scenario request, wherein the scenario request comprises a set a scenario type and a scenario parameter set;
wherein risk scoring circuitry is further configured to generate, based on a corresponding entity asset type, a corresponding geographic area, and the scenario request, one or more predicted risk scores for each entity asset included in the entity asset set;
wherein the insight circuitry is further configured to generate, based on the one or more predicted risk scores, one or more predicted insights for each entity asset included in the entity asset set, wherein the each insight is indicative of an inferred cause for a predicted risk score associated with the entity asset; and
wherein communications hardware is further configured to provide a scenario response, wherein the scenario response comprises the one or more predicted insights.

20. A computer program product for generating an insight report for an entity, the computer program product comprising at least one non-transitory computer-readable storage medium storing software instructions that, when executed, cause an apparatus to:
identify an entity asset set for the entity, wherein (i) the entity asset set comprises one or more entity assets associated with the entity, (ii) each entity asset is associated with an entity asset type, and (iii) each entity asset is further associated with a geographic area;
determine, based on a corresponding entity asset type and a corresponding geographic area, one or more risk scores for each entity asset included in the entity asset set;
generate, based on the one or more risk scores, one or more insights for each entity asset included in the entity asset set, wherein the each insight is indicative of an inferred cause for a risk score associated with the entity asset;
generate the insight report for the entity, wherein the insight report comprises the one or more insights; and
provide the insight report.
